(19) United States
(12) Patent Application Publication
(10) Pub. No.: US 2014/0331278 A1
(43) Pub. Date: Nov. 6, 2014

(54) SYSTEMS AND METHODS FOR VERIFYING IDENTITIES

(71) Applicant: Dmitri Tkachev, New York, NY (US)

(72) Inventor: Dmitri Tkachev, New York, NY (US)

(21) Appl. No.: 14/098,287

(22) Filed: Dec. 5, 2013

Related U.S. Application Data
(63) Continuation-in-part of application No. 13/875,218, filed on May 1, 2013.
(60) Provisional application No. 61/873,964, filed on Sep. 5, 2013.

(51) Int. Cl. H04L 29/06

(52) U.S. Cl. CPC H04L 63/08; H04L 63/20
USPC 726/1

(57) ABSTRACT

A method for authenticating the identity of a principal is provided. The method may include storing security information related to a principal which includes a plurality of guardians, as well as contact information and rating information for each. The method may include storing a security policy related to a requester, the security policy comprising a security set having verification parameters. The method may include receiving a request to authenticate the identity of the principal. The method may include selecting particular guardians based at least in part on the verification parameters. The method may include establishing communication links, using the contact information, between the principal and each of selected guardians. The method may include determining a result of each communication link authentication session, and based at least in part on the results, the rating information, and the verification parameters determining whether the principal is authenticated.

### CROSS-REFERENCE TO RELATED APPLICATIONS

This application is a continuation-in-part of U.S. patent application Ser. No. 13/875,218 filed May 1, 2013, entitled “METHODS AND SYSTEMS FOR IDENTIFYING, VERIFYING, AND AUTHENTICATING AN IDENTITY,” the entire disclosure of which is hereby incorporated by reference, for all purposes, as if fully set forth herein.

This application also claims priority to, and the benefit of, U.S. Provisional Patent Application No. 61/873,964 filed Sep. 5, 2013, entitled “SYSTEMS AND METHODS FOR VERIFYING IDENTITIES,” the entire disclosure of which is hereby incorporated by reference, for all purposes, as if fully set forth herein.

### BACKGROUND OF THE INVENTION

Current identity verification systems and methods for security purposes, including, but not limited to, personal identity cards, passports, passwords, personal handheld devices, symmetric and asymmetric encryption, public-key cryptography, multi-factor authentication methodologies, including biometric identity verification (fingerprint, retina scans, body structure, physical and chemical composition on molecular and atomic levels, etc.) are subject to replication and man-in-the-middle attacks, as these identification features can be replicated with no deviations from the original. These systems rely on possession of physical and digital keys, physical features, or characteristics of the user which thus increases the opportunity for attack and decreases security by relying on identity verification subject to information given by the user. This security risk is as applicable to remote identity verification systems as it is to physical in-person identity checks because it relies on physical properties, objects, or knowledge that a user must provide. This makes current remote identity verification systems inherently insecure against man-in-the-middle attacks allowing intruders to gain access by means of replication.

Further risks are present when a user himself performs or is involved in the process of verifying his identity; in addition to the risks of traditional man-in-the-middle attacks, possession of private keys can be obtained by means of coercion or extortion, whether direct or indirect. In such instances the ability to detect intrusion is minimal, as the user may not be able to report the intrusion until after the attack is over. Even the implied security strength of a one-time pad, or any other single-use encryption key, is diminished against such an intrusion.

In the event a user loses access information, current identity verification systems are insecure, inconvenient, and time consuming when providing reset functionality as they require additional information from the user or rely on third-party services to reset access to a system. A user may lose access information via loss of a one-time pad, password, private key, memory, physical characteristic (biometric data points damage, for example, damage to facial, fingerprint, iris, DNA, etc.), mobile device, wearable device, or mobile token generator. Further, in situations where even one version of a user's identification feature or security credentials such as, for example, a password becomes compromised, a chain reaction (a sequence of reactions where a product or by-product of one event causes additional reactions and events to take place) of security breaches for a particular user or group of users across multiple access points may also be compromised where the same identification feature or security credential provides access at all such access points. Alternatively, in systems where password or access reset procedures are not available for security reasons, such as, for example, encrypted file storage, complete loss of access may occur.

Even when encryption and decryption algorithms are used, their use may be complicated by the inability of a user to remember multiple password or key combinations. Also, the requirement of the user to change access keys or passwords on a regular basis is time consuming and subject to eavesdropping and password or key capture. In addition, many current access systems cannot prevent a user that has provisions for access from accessing the system whether consciously, for malicious purposes, or unconsciously, in situations where the user has an altered state of mind due to chemical imbalances within the body from natural causes or under influence of outside elements, whether chemical, physical or alternative agents impacting their behavior or mental state.

### BRIEF SUMMARY OF THE INVENTION

In one embodiment, a machine implemented method of authenticating the identity of a principal is provided. The method may include storing security information related to a principal. The security information may include identifiers representing a plurality of guardians, contact information for each identifier, and rating information for each identifier. The method may also include storing a security policy related to a requester, where the security policy comprises a first security set having verification parameters. The method may further include receiving, from the requester, a request to authenticate the identity of the principal. The method may additionally include selecting a subset of the identifiers, where the subset is selected based at least in part on the verification parameters. The method may moreover include attempting to establish communication links, based at least in part on the contact information, between the principal and each of the guardians represented in the subset of identifiers. The method may furthermore include determining a result of a query to each of the guardians for whom a communication link with the principal is established, the query asking each guardian whether the principal is a specified party. The method may also include determining, based at least in part on the results, the rating information, and the verification parameters whether the principal is authenticated as the specified party. The method may further include sending, based at least in part on whether the principal is authenticated, an authentication message.

In another embodiment, a non-transitory machine readable medium having instructions stored therein for authenticating the identity of a principal is provided. The instructions may be executable by a machine to store security information related to a principal. The security information may include identifiers representing a plurality of guardians, contact information for each identifier, and rating information for each identifier. The instructions may also be executable to store a security policy related to a requester, where the security policy comprises a first security set having verification parameters. The instructions may further be executable to receive, from the requester, a request to authenticate the identity of the principal. The instructions may additionally be executable to select a subset of the identifiers, where the subset is selected based at least in part on the verification parameters. The instructions may furthermore be executable to determine a result of a query to at least one of the subset of the guardians, the query asking each guardian whether the principal is a specified party. The instructions may also be executable to determine, based at least in part on the results, the rating information, and the verification parameters whether the principal is authenticated as the specified party. The instructions may further be executable to send, based at least in part on whether the principal is authenticated, an authentication message.

In another embodiment, a system for authenticating the identity of a principal is provided. The server may be configured to store security information related to a principal. The security information may include identifiers representing a plurality of guardians, contact information for each identifier, and rating information for each identifier. The server may also be configured to store a security policy related to a requester, where the security policy comprises a first security set having verification parameters. The server may further be configured to receive, from the requester, a request to authenticate the identity of the principal. The server may additionally be configured to select a subset of the identifiers, where the subset is selected based at least in part on the verification parameters. The server may moreover be configured to establish communication links, based at least in part on the contact information, between the principal and each of the guardians represented in the subset of identifiers. The server may furthermore be configured to determine a result of a query to each of the guardians for whom a communication link with the principal is established, the query asking each guardian whether the principal is a specified party. The server may also be configured to determine, based at least in part on the results, the rating information, and the verification parameters whether the principal is authenticated as the specified party. The server may further be configured to send, based at least in part on whether the principal is authenticated, an authentication message.

### BRIEF DESCRIPTION OF THE DRAWINGS

Many aspects of the present disclosure can be better understood with reference to the following figures. Moreover, in the drawings, like reference numerals designate corresponding parts throughout the several views.

FIG. 1 is a block diagram showing an exemplary client system configured to provide a user identification tool.

FIG. 2 is a block diagram showing an exemplary method performed by an identity authentication application on a client device.

FIG. 3 is a block diagram showing an exemplary method performed by an identity authentication service on a server.

FIG. 4 is a block diagram showing an exemplary registration process for a user of the systems and methods herein.

FIG. 5 is a block diagram illustrating an example social circle of a user.

FIG. 6 is a block diagram illustrating an example of a potential implementation of authentication interface and peer-to peer verification.

FIG. 7 is a block diagram of an exemplary implementation of real-time authentication agent rotation.

FIG. 8 is a block diagram of an exemplary implementation of additional security policies incorporated in the verification agent module.

FIG. 9 is a block diagram of an exemplary implementation where a third party uses the user identification system for user verification.

FIG. 10 is a block diagram of an exemplary implementation where a third party uses the system for user verification and provides additional services to the user as per the third party's provisioning rules.

FIG. 11 is a block diagram of an exemplary implementation of multi-user group verification, where each member of the group is separately verified.

FIG. 12 is a block diagram of an exemplary implementation of multi-group user verification where after each respective member of the group is confirmed, all or selected group members perform a second layer of verification.

FIG. 13 is a block diagram of an exemplary implementation showing the incorporation of a session integrity security suite.

FIG. 14 is a block diagram showing an example of a unique data mask generation for security purposes as one of the applications.

FIG. 15 is a block diagram showing an example of a data analysis for an authentication agent incorporating privacy and security demands.

FIG. 16 is a block diagram showing an exemplary method for verifying the identity of a party.

FIG. 17 is a block diagram showing another exemplary method for verifying the identity of a party.

FIG. 18 is a schematic drawing of an exemplary implementation of an electronic device capable of detecting gestures, possibly by means of a capacitive sensor, or external movement sensors/cameras, depicting several gestures of a hand/finger(s) used to ensure intentional user input as a result of a verification decision made by the guardian, and to mitigate number of potential false-positive and false-negative verification outcomes due to user input error.

FIG. 19 is a schematic drawing of an exemplary implementation of an electronic device capable of detecting gestures, possibly by means of a capacitive sensor, or external movement sensors/cameras, depicting several advanced gestures of a hand/finger(s) used to ensure intentional user input as a result of a verification decision made by the guardian, and to mitigate number of potential false-positive and false-negative verification outcomes due to user input error.

FIG. 20 is a schematic drawing of an exemplary implementation of an electronic device capable of detecting gestures, possibly by means of a capacitive sensor, or external movement sensors/cameras, depicting several advanced gestures with varying pathways and/or dynamically changing pathways of a hand/finger(s) used to ensure intentional user input as a result of a verification decision made by the guardian.

FIG. 21 is a schematic drawing of an exemplary implementation of an electronic device capable of detecting gestures, possibly by means of a capacitive sensor, or external movement sensors/cameras, depicting several advanced gestures with varying pathways and/or dynamically changing pathways of a hand/finger(s) used to ensure intentional user input as a result of a verification decision made by the guardian.

FIG. 22 is a schematic drawing of an exemplary implementation of an electronic device capable of detecting gestures, possibly by means of a capacitive sensor, or external movement sensors/cameras, depicting several advanced gestures of a hand/finger(s) used to ensure intentional user input as a result of a verification decision made by the guardian, and to mitigate number of potential false-positive and false-negative verification outcomes due to user input error.

FIG. 23 is a schematic drawing of an exemplary implementation of a wrist-mounted electronic device capable of detecting gestures, possibly by means of a capacitive sensor, or external movement sensors/cameras, depicting several advanced gestures of a hand/finger(s) used to ensure intentional user input as a result of a verification decision made by the guardian, and to mitigate number of potential false-positive and false-negative verification outcomes due to user input error.

FIG. 24 is a schematic drawing of an exemplary implementation of a wrist-mounted electronic device capable of detecting gestures, possibly by means of a capacitive sensor, or external movement sensors/cameras, depicting several advanced gestures of a hand/finger(s) used to ensure intentional user input as a result of a verification decision made by the guardian, and to mitigate number of potential false-positive and false-negative verification outcomes due to user input error.

FIG. 25 is a schematic block diagram of an exemplary implementation of notification and verification session facilitation between guardians/recipients and principals/senders based on a set of conditions, variables, and incentives defined by each respective party in the message payload associated with a message body/verification request notification.

FIG. 26 is a schematic drawing of an exemplary implementation of a notification message and verification request on an electronic device.

FIG. 27 is a schematic drawing of an exemplary implementation of a sender-specific verification notification control policy on an electronic device, allowing a guardian to setup notification acceptance/deferral/filtering policy for each principal.

FIG. 28 is a block diagram illustrating an example of a potential implementation of a verification circle accepting inputs of human guardians as well as inputs from electronic devices belonging to a principal, other electronic input/output devices not belonging to the principal, third party inputs, and individuals not directly related to the principal.

FIG. 29 is a block diagram illustrating an example of a potential implementation of a verification circle of guardians, leveraging not only direct verification inputs from guardians, but leveraging the computation and storage resources provided by the electronic devices belonging to guardians, accepting inputs of human guardians as well as inputs from electronic devices, third party inputs and individuals not directly related to the principal.

FIG. 30 is a block diagram of an exemplary implementation of a verification circle having second- or third-derivative guardians, with their respective devices, and respective social circles of the principal user's guardians' as another deterrent against intrusion and n-degree validation of a principal's guardians by their own respective networks of guardians.

FIG. 31 is a block diagram of an exemplary implementation having both one-on-one verification sessions, as well multi-guardian verification sessions where multiple guardians are present within the same verification session.

FIG. 32 is a block diagram of an exemplary method of identifying guardian(s) availability for a verification session of a principal based on matching of conditions required both by guardians and principals to proceed with a verification session.

### DETAILED DESCRIPTION OF THE INVENTION

The ensuing description discloses exemplary embodiments only, and is not intended to limit the scope, applicability, or configuration of the disclosure. Rather, the ensuing description of the exemplary embodiments will provide those skilled in the art with an enabling description for implementing various possible embodiments. Various changes may be made in the function and arrangement of elements without departing from the spirit and scope of the invention as set forth in the appended claims.

Specific details are given in the following description to provide a thorough understanding of the described embodiments. However, it will be understood by one of ordinary skill in the art that the embodiments may be practiced with or without these specific details. For example, circuits, systems, networks, processes, and other elements in the invention may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed, but could have additional steps not discussed or included in a figure. Furthermore, not all operations in any particularly described process may occur in all embodiments. Finally, any detail discussed with regard to one embodiment may or may not be present in any other described or implicit embodiment of the invention. A process may correspond to a method, a function, a procedure, a subroutine, a subprogram, etc. When a process corresponds to a function, its termination corresponds to a return of the function to the calling function or the main function.

The term “machine-readable medium” includes, but is not limited to, portable or fixed storage devices, optical storage devices, wireless channels and various other mediums capable of storing, containing or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Furthermore, embodiments of the invention may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

Broader Implications of the Invention

Some inventions may bring value to society by improving quality of life and scaling efficiencies of the processes which drive the society forward. However, some advancements may not receive broader adoption because they are too technical or isolated from the human element, especially for casual potential adopters, limiting the advancement's reach. The technology discussed herein leverages the human factor, and potentially prevents attempts by would-be intruders to obtain physical access or electronic access to processes, property, knowledge, and valuables by means of coercion and physical harm to individuals, their family members, and loved ones.

The broader implications of the methods and processes discussed herein not only provide a strong disincentive against intrusion by means of coercion, but provides a last line of defense in situations where memory loss results in irreversible loss of access with associated consequences to an individual or entity. This may be accomplished without providing a backdoor shortcut solution where there may be some interest, for the sake of mere convenience, for access to be reinstated without proper following of security protocols.

The methods and systems discussed herein may leverage the human factor already distributed throughout the society as a strong deterrent against harm, intrusion, data loss, and property theft, as well as provide many other advantages. Additionally, the technology can fun and simple—leveraging the human factor and strength of our social bonds to facilitate creation of a deterrent against intruders willing to break the social norms, as well as the letter and spirit of the law.

Embodiments include client devices configured to provide an effective mechanism for dynamically providing identity verification and authentication of a user utilizing the user's social circle of established relationships as verification agents. For the purposes of this disclosure, “verification” and “authentication,” as well as their assorted forms, may be used interchangeably, and may mean to prove, confirm, substantiate, and/or establish the truth of a given assertion or matter. For example, client devices may execute an application or applications, embodied in a non-transitory computer-readable medium, that include instructions for performing the methods of verifying and/or authenticating an identity of a user, and authorizing access to a system or services described herein based on successful verification and/or authentication.

In some embodiments, upon initiation of an authentication request by the user in need of verifying his identity, the system may initiate a process in which it dynamically and randomly selects one or more pre-approved members of the user's social circle, creating a list of authentication agents made up of the selected members. The pre-approved members may themselves be selected during a vetting process applied to individuals submitted by the user as belonging to their social circle. The system then initiates a secure communication or a series of communication sessions between the user and each respective authentication agent for the two parties in each pair to interact in a written (chat), oral (voice), or visual (video) manner, depending on device capability and/or availability for each respective party.

Via secure communications, the system enables the user and the chosen verification agent to interact so that the verification agent can verify the identity of the user. These communications may take from a few seconds to as long as necessary for the authentication agent to ensure that they are interacting with the person they are to identify. Additionally, communications may occur in real time (i.e., telephone, voice chat, video chat) or via delayed methods (i.e., text message, emails, etc.), or a combination of multiple communication methods established either concurrently or sequentially. In some embodiments, the user and the chosen verification agent may be in close proximity so that personal face-to-face communication may instead occur, without the need to establish a secure communication transmission or connection between the two individuals, while still maintaining the secure communication channel with each respective individual. Once the authentication agent is confident of the user's identity, based on his or her prior knowledge of the user in question relative to current interaction established by embodiments of the invention with the user, the authentication agent provides a confirmation to the system by means of visual, oral, physical feedback, a combination of these means, and/or a predetermined sequence of actions/events.

The system records the outcome (whether confirmation or rejection) from the current authentication agent and repeats the process with as many authentication agents as necessary to either meet or fail to meet predefined security requirements, dynamically cycling through the user's vetted authentication agents of his social circle stored within the user's verification profile together with user-specific security policy and notification triggers, other user-specific data points and conditions, as well as other conditions necessary for a user to satisfy prior to receiving authentication confirmation. Once the required number of identity authentication confirmations is received, the system issues a confirmation of the user's identity, which may be used to grant access or authorization for the user to a particular system, service, or trigger a predefined sequence of actions, etc.

This illustrative embodiment employs a user's social circle of established social relationships and peer-to-peer human connections to dynamically provide verification and authentication of a user's identity, so that authorization may be granted to the user to access a provided system or service. In some embodiments then, this process relies on a dynamically created and randomly selected, in compliance with pre-specified rules, set of a user's social connections to verify the user's identity. The user's social circle may include, but is not limited to, the user's family members, friends, colleagues, acquaintances, and individuals in close and/or regular contact with the user. Embodiments herein allow for incorporating additional predefined authorization agents based on security requirements, for example in corporate, government, and high security environments. The method ensures randomization of verification counterparts within the user's social circle to avoid repetitive selection, thus minimizing chances of security attacks and actual breaches.

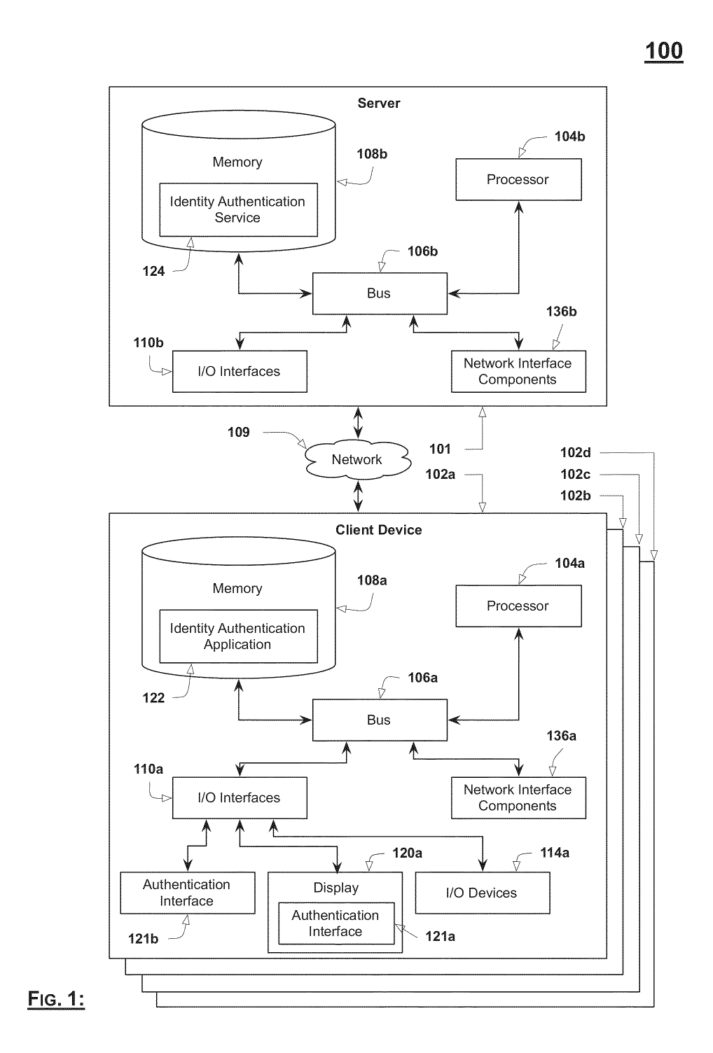

FIG. 1 is a block diagram showing an exemplary networked environment 100 for implementation of various embodiments of the invention. The networked environment includes a server 101, a plurality of client devices 102 and a network 109. The server 101 and the plurality of client devices 102 are connected to or capable of connecting to the network 109. The network may be or include, for example, any type of wireless network such as a wireless local area network (WLAN), a wireless wide area network (WWAN) or any other type of wireless network now known or later developed. Additionally, the network 109 may be or include the Internet, intranets, extranets, microwave networks, satellite communications, cellular systems, PCS, infrared communications, global area networks, or other suitable networks, etc., or any combination of two or more such networks. The network 109 facilitates transmission of communications and resources between or among two or more of the client devices 102.

The server 101 may comprise, for example, a server computer or any other system for providing the identity authorization services as described herein to the client device(s) 102. In some embodiments, a plurality of servers 101 may be employed and arranged, for example, in one or more server banks or computer banks or other arrangements. In some embodiments, a plurality of otherwise independent devices, possibly mobile client devices, may act in unison/concert to provide similar functionality as server 101. For example, a plurality of servers 101 together may comprise a cloud computing resource, a grid computing resource, and/or any other distributed computing arrangement. Such servers 101 may be located in a single installation or may be distributed among many different geographic locations. For purposes of convenience, the server 101 is referred to herein in the singular. A client device 102 may comprise a desktop, a laptop, a tablet, a PDA, a mobile phone or any other suitable computing device configured for performing or participating in the identity verification processes as described herein.

The server 101 and each client 102 include a processor 104a,b and a memory 108a,b for storing data, software application programs, program modules, software services and processes, and other computer-executable instructions. The processor 104a,b has access via bus 106a,b or other appropriate interface to the memory 108a,b and is configured for executing the computer-executable instructions included in the various application programs and services. A memory 108a,b may be any tangible computer-readable medium, such as RAM, ROM, cache, or Flash memory and/or any other integrated, removable, or otherwise accessible storage medium. Software applications and services stored in the memory 108a,b may include an operating system, an “identity authentication application” 122 (client device 102), an “identity authentication service” 124 (server 101) and any other suitable application program(s), software module(s), software component(s), etc. As used herein, the terms “identity authentication application” 122 and “identity authentication service” 124 are intended to represent software application(s) and service(s) for performing the client-side and server-side functions, respectively, of the identity authentication processes described herein.

Each client device 102 may also include input-output (I/O) interface components 110, which may comprise one or more other busses, ports, or other interconnections etc. for facilitating connection with various devices included in or interfaced to client platform 102, such as a display device 120 and other I/O devices 114 (e.g. a mouse, keyboard, touch screen interface, etc.). These components may optionally be included in the server 101 as well.

The server 101 and each client device 102 also includes a network interface 112a,b, which may include a wired network connectivity component, for example, an Ethernet network adapter, a modem, and/or the like. A networking interface 112a,b may further include a wireless network connectivity component or interface for a wireless network connectivity component, for example, a PCI (Peripheral Component Interconnect) card, USB (Universal Serial Bus) interface, PCMCIA (Personal Computer Memory Card International Association) card, SDIO (Secure Digital Input-Output) card, NewCard, Cardbus, a modem, a wireless radio transceiver, and/or the like. The server 101 and each client device 102 may thus be operable to communicate with other network devices via a wired and/or wireless connection to the network 109. Other components of typical computing devices and networks are well-known in the art but, for the sake of brevity, are not explicitly described herein.

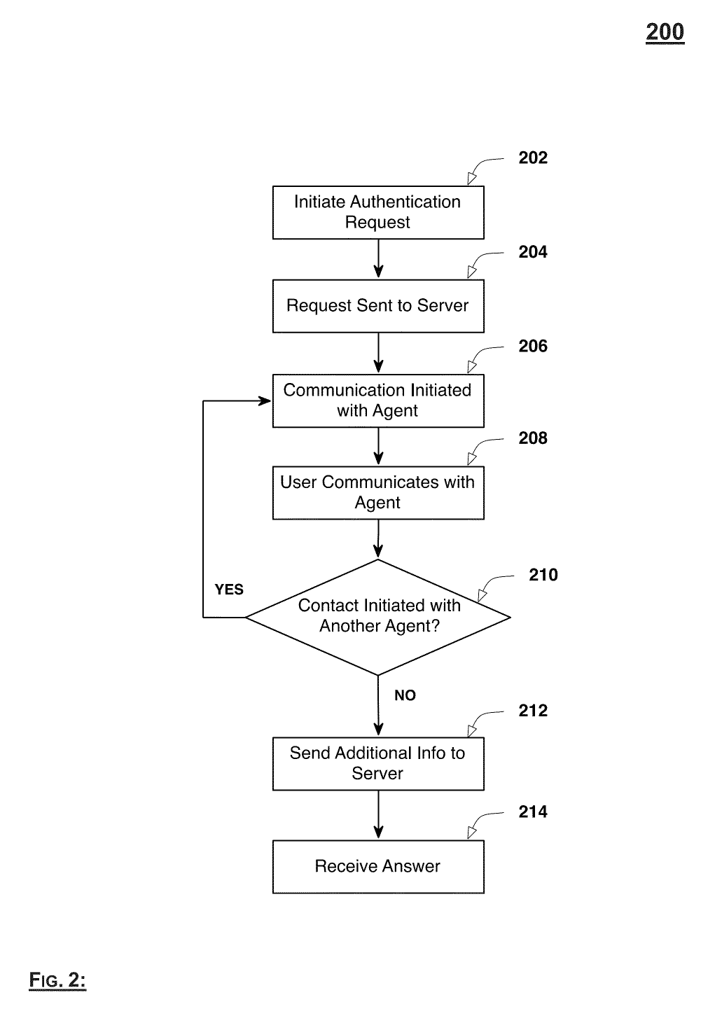

FIG. 2 is a diagram showing steps in an exemplary method 200 of verifying the identity of a user from the perspective of the client device 102. At block 202, the user initiates a request via an authentication interface 121a,b generated by the identity authentication application 122 that can be established by several means 121b such as being displayed 121a on the client device 102. At block 204, the identity authentication application 122 sends the request to the identity authentication service 124.

At block 206, a communication is initiated between the user and a first authentication agent. This communication may be accomplished on the client device 102 via voice, text, e-mail, or any other available means of the client device 102, or may be accomplished using another device, for example, a separate telephone line, computing device, etc. The communication may be one or more discrete communications, or may be via a continuous communication connection for a duration of time. Furthermore, the communications may or may not pass through the server 101. In some embodiments the server 101 may facilitate, and possibly monitor the communication, while in other embodiments it may facilitate establishment of the initial connection between user and authentication agent by provision of secure encryption keys to allow a user and verification agent to establish the session, hence ensuring that the communication is secured by means of individual encryption keys without which the communication cannot take place, while the pathway of the connection may not necessarily be facilitated directly by the server and can be done in a decentralized manner via public networks/communication channels, and/or an array of intermediaries.

At block 208, the user communicates with the first authentication agent until the first authentication agent can either confirm or reject the identity of the user to identity authentication service 124 that the user is who he/she says he/she is. The first authentication agent may confirm this by recognizing, as one of potential identification targets, the speech, visual expressions of the user, discussing shared experiences, etc.

At block 210, if the identity authentication service 124 determines, or has determined, that further authentication agents are necessary to authenticate the user, then the identity authentication service 124 may cause the user to submit to further identity authentication by repeating the process of blocks 206, 208 with another authentication agent selected by identity authentication service 124. This may occur in embodiments where multiple independent authentication checks are required for the specific identity verification process performed.

At block 212, once all authentication agents selected by the identity authentication service 124 have been communicated with, the client device 102 may send additional information necessary for verification, as will be discussed herein, to identity authentication service 124. At block 214, client device 102 may receive an answer from the server 101 regarding the requested authentication. This response may either be affirmative or negative based on an evaluation by the server 101 of the information received from the authentication agents and the client device 102.

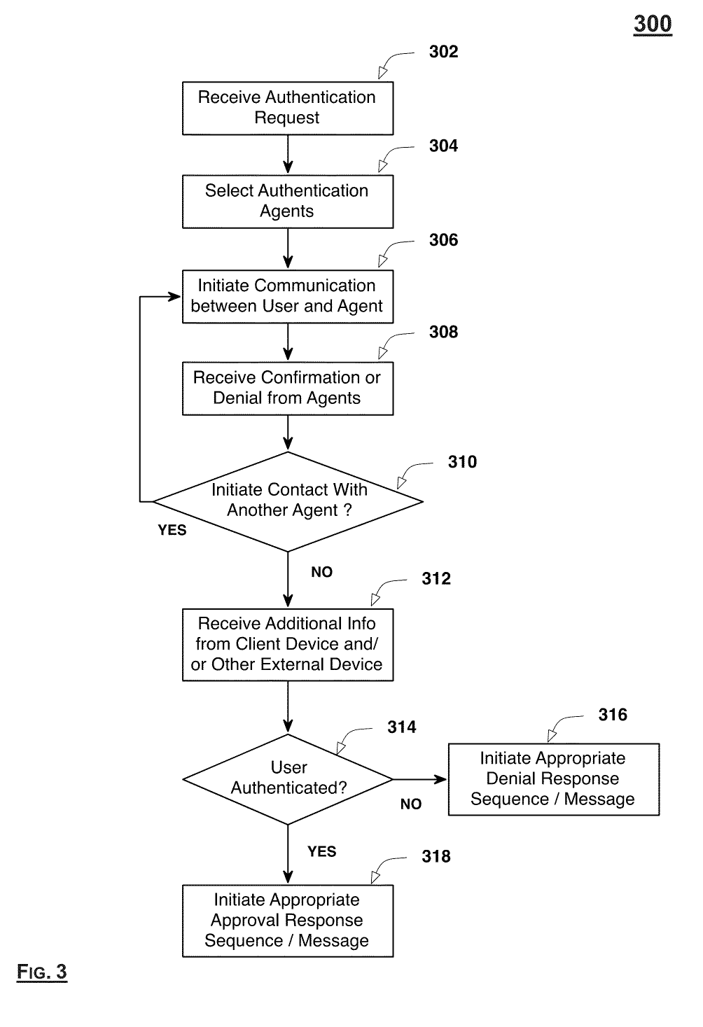

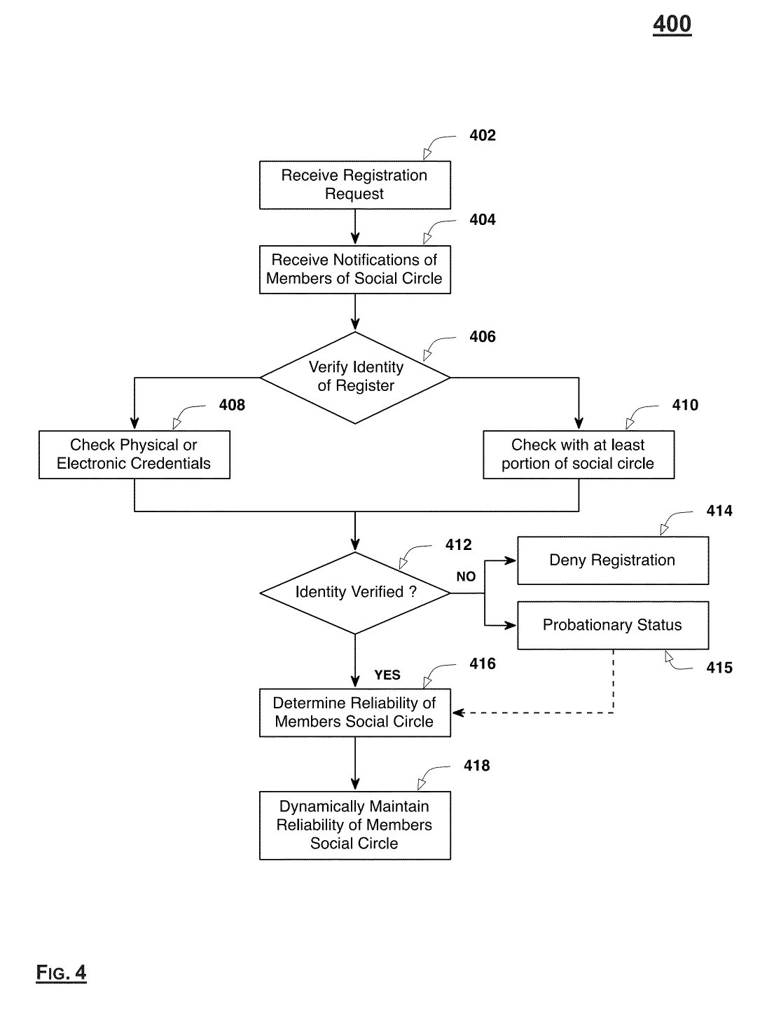

FIG. 3 is a diagram showing steps in an exemplary method 300 of verifying the identity of a user from the perspective of the server 101. At block 302, the identity authentication service 124 receives a request to authenticate the identity of a user. At block 304, the identity authentication service 124 selects authentication agents associated with the user. How these agents are selected will be discussed below with respect to FIG. 4.

At block 306, a communication is initiated between the user and a first authentication agent. This communication may be accomplished on the client device 102 via voice, text, e-mail, or any other available means of the client device 102, or may be accomplished using another device, for example, a separate telephone line, computing device, etc. At block 308, the identity authentication service 124 receives a confirmation or denial from the authentication agent that the user is who he/she claims to be.

At block 310, if the identity authentication service 124 determines, or has determined, that further authentication agents are necessary to authenticate the user, then the identity authentication service 124 may cause the user to submit to further identity authentication by repeating the process of blocks 306, 308 with another authentication agent selected by identity authentication service 124 (perhaps at block 304). This may occur in embodiments where multiple independent authentication checks are required for the specific identity verification process performed. While one authentication session is in process, the system may automatically check the availability of other identification agents of user's social circle, and queue them accordingly to minimize potential delays between authentication sessions between the user and each respective identification agent.

Which, and how many, authentication agents are selected from the user's social circle may be dependent on a number of factors, which can be predefined for each specific application of authentication session and stored accordingly in the user profile as will be discussed herein. Additionally, the weight accorded to any given authentication agent may also be dynamic, and also therefore affect the number of authentication agents determined necessary for a particular authentication.

Once all identity authentications have occurred with the selected authentication agents, additional information may be received from the client device at block 312. This information, as will be discussed herein, may provide further data points that can be analyzed to authenticate the user. At block 314, the identity authentication service 124 may determine whether the user is authenticated from the information collected at blocks 308, 312. Additionally or alternatively, a notification may also be sent to an entity, service, or system requesting further authentication of the user's identity.

If the first authentication agent, an authentication agent subsequent to the first, or a threshold number or portion of the authentication agents do not confirm the identity of the user, then at block 316, authentication of the user's identity is denied and the identity authentication service 124 may send an authentication denial message to client device 102 and/or an entity, service, or system requesting authentication of the user's identity. However, if the first authentication agent, an authentication agent subsequent to the first, or a threshold number or portion of the authentication agents do not confirm the identity of the user, then at block 318, authentication of the user's identity is confirmed and the identity authentication service 124 may send an authentication approval message to client device 102 and/or an entity, service, or system requesting authentication of the user's identity.

Social Circle: Human Bonds, Relationships and Peer-to-Peer Connections

The user's social circle is a set of individuals who are connected by some relationship to the user, which can be personal, and/or professional, and/or required by third party agents (government officials, border control, public servants, police officers, border agents, etc.). For example, individuals in the user's social circle may include friends, family members, acquaintances, colleagues, or any other person associated with the user.

In some embodiments, members of the user's social circle may be provided by third parties whose systems and processes will use the instant system to verify the identity of a person attempting access. For example, depending on the purpose of authentication and associated security requirements, such as corporate, government, high security applications, additional functionality allows adding specific pre-defined members such as administrators, IT support, managers, supervisors, etc., to the list of identification agents to be contacted as required for access. In these instances, in addition to using one's traditional social circle the access at that specific authentication step for that particular application will only be provided once the user is authenticated by the specific member of a group (administrators, IT support, managers, supervisors, authorized external parties) in addition to the agents selected from members of the user's personal social circle.

Dynamic Trustworthiness Factor Assessment

At each step the system may dynamically calculate and take into the account the trustworthiness factor of both the verification agent and user to structure verification policies in accordance with fraud minimization techniques. Thus, at any time the system may determine that adequate information has been received to make an authentication determination, regardless of a whether a positive or negative authentication determination will be made. Likewise, at any time the system may determine that the authentication process is not complete, and requires further data, via either authentication agents or other sources, to make a final determination.

Initially, all suggested agents are eligible to act as verification agents as long as they are willing to participate in the program and act as verification agents for the user who selected them to act as verification agents. However, over time as more and more verification sessions take place, a pattern will appear of some verification agents always being responsive in their availability and responsible in their judgment, respectively, while others being out of reach or irresponsible, resulting in false-negative verification outcomes, in instances when they intentionally decided to reject the confirmation requests to play a prank or be rude or disrespectful to the user who asked to be verified. Similar data aggregation and analytics methodologies are used by the service to analyze how many false positive and false negative outcomes each particular verification agent provided versus the overall number of verification sessions. The system will analyze for presence of any specific patterns, for example, when the largest amount of incorrect verification outcomes for a particular verification agent took place during a certain time window, and will ensure in the future to avoid using this particular person as a verification agent during that time window, will reduce the trustworthiness score of this person as a verification agent and will initiate fewer verification requests. The system can analyze the trustworthiness of verification outcomes both on a per user basis and per verification agent basis.

Trustworthiness Factor Verification Parameters

However, if a verification agent is already a registered user of the service with its own circle of verification agents, this will naturally increase the initial trustworthiness of this particular agent, as it reduces a chance of man-in-the-middle attack, where multiple fake accounts have been created for the sole purpose of stealing someone's identity done by creating a fake identity of a user who had not yet created a profile and verifying it by a set of fake verification agents to obtain fake identity of that user unaware of the fraud attempt.

Additional verification parameters may include but are not limited by the amount of time a person had the profile, the amount of social connections and interactions in the public domain within social networks, as well as personal publications, appearances in press, length of time that person had profiles at social networks, as well as confirmations from public databases, corporate and government agencies, etc. For example, a user with little social activity and recently established public social profiles, might require additional verification steps versus the ones who have been active, on a relative basis, as it would prevent someone from receiving a validation.

In addition, for those verification agents with the lowest rates of false-negative and false-positive verification sessions as well as those with the most availability or quickest reaction time, the system provides an incentive-based system.

In one of the implementations, for some of the less critical verification sessions, the system provides an ability for the user to hire a designated agent or group of agents, reducing the strain on members of the user's social circle for some of the less critical verification sessions. This can be particularly applicable to large volumes of verification requests in corporate settings, where a designated set of verification agents might be used in addition to a user's social circle, colleagues, and administrators.

In addition for new users a system might use traditional means of in-person calls, identity checks, communication via traditional communication channels such as email and post mail to notify the user of the profile creation and verify user identity by traditional identity verification measures and techniques.

Registration Process

FIG. 4 is a block diagram showing an exemplary registration process 400 for a user of the systems and methods disclosed herein. At block 402, a server 101 receives a registration request from a user. At block 404, the server 101 receives notification of who are members of the social circle of the user. The user's social circle is a set of individuals who are connected by some relationship to user. For example, individuals in the user's social circle may include friends, family members, acquaintances, colleagues, or any other person(s) associated with the user who knows the user well enough to act as a verification agent.

In some embodiments, members of the user's social circle may be provided by third parties whose systems and processes will use the instant system to verify the identity of a person attempting access. For example, depending on the purpose of authentication and associated security requirements, such as corporate, government, and/or high security applications, additional functionality allows adding specific pre-defined members such as administrators, IT support, managers, supervisors, etc., to the list of identification agents to be contacted as required for user verification and access. In these instances, in addition to using one's traditional social circle the access at that specific authentication step for that particular application will only be provided once the user is authenticated by the specific member of a group (administrators, IT support, managers, supervisors, authorized external parties) in addition to members of the user's personal social circle.

At block 406, verification of the identity of the user begins to ensure the person attempting to register is indeed who he/she purports to be. Verification may occur in at least one manner. In one possible embodiment, at block 408, physical or electronic credentials are checked by the system, or by a combination of system-provided resources and third parties performing in-person verification. Physical credentials could include identification cards or other physical objects, for example passports and the like which could be used to verify the identity of the user, and physical characteristics of the user (biometric data, etc.). Electronic credentials could include any identifying data that could be checked against another source or database. Merely by way of example, information known, or probably only known to the user, including a Social Security number, mother's maiden name, prior places of residence and/or employment, biometric data, etc.

Alternatively or additionally, at block 410 the process previously discussed with regard to FIGS. 1 and 2 could be employed to check with those identified in the social circle to verify the identity of the user. Members of the social circle who have previously been identified and verified as trusted authentication agents for other users could be trusted, or assigned higher trust value, to make this identification of the new user. In similar fashion, if a verification agent already is a registered user of the system having his/her own profile and respective circle of authentication agents, it will inherently assign higher trust value to this user acting as a verification agent for another user.

At block 412, it is determined whether information collected at blocks 408, 410 is sufficient to verify the identity of the user attempting registration. If such information is sufficient, then at block 416 the user is verified, and the reliability of each member in the social circle is determined, to be further dynamically maintained and updated over time at block 418. The reliability of each member in the social circle determines what weight a positive confirmation of identity from the member will carry during an authentication process. The identities of the members of the social circle, as well as their reliability, may be stored in a profile for the user for future use during authentication processes as described with regard to FIGS. 1 and 2. In some embodiments, the members of the social circle will also be contacted to verify they are willing and able to serve as authentication agents. While in some embodiments relative trustworthiness weight might be assigned and applicable, in others it may not be as relevant, depending on privacy policy and use-case scenarios.

If the identity of the user is not verified, then registration with the system is either denied at block 414, or is done on probationary basis at block 415 resulting in additional subsequent verification steps and procedures done via several possible routes (for example, in-person verification via hardcopy documents (i.e., drivers license, passport, etc.)), at which point user will receive verified status, at block 416, and the full range of functionality and subsequent services provided by the service. Appropriate notifications may be delivered to the user and/or any other system assisting with the registration process. Additional actions, scripts and sequences might be initiated such as, for example, logging all the attempts with associated secondary data points (IP addresses, time, location, etc.) and notifications may be sent to third parties of any attempted, failed, and potentially fraudulent registration attempts, including for example credit reporting agencies, law enforcement, and/or third parties associated with the real individual for which registration was attempted (the real individual, their employer, etc.).

Exemplary Instance of Social Circle

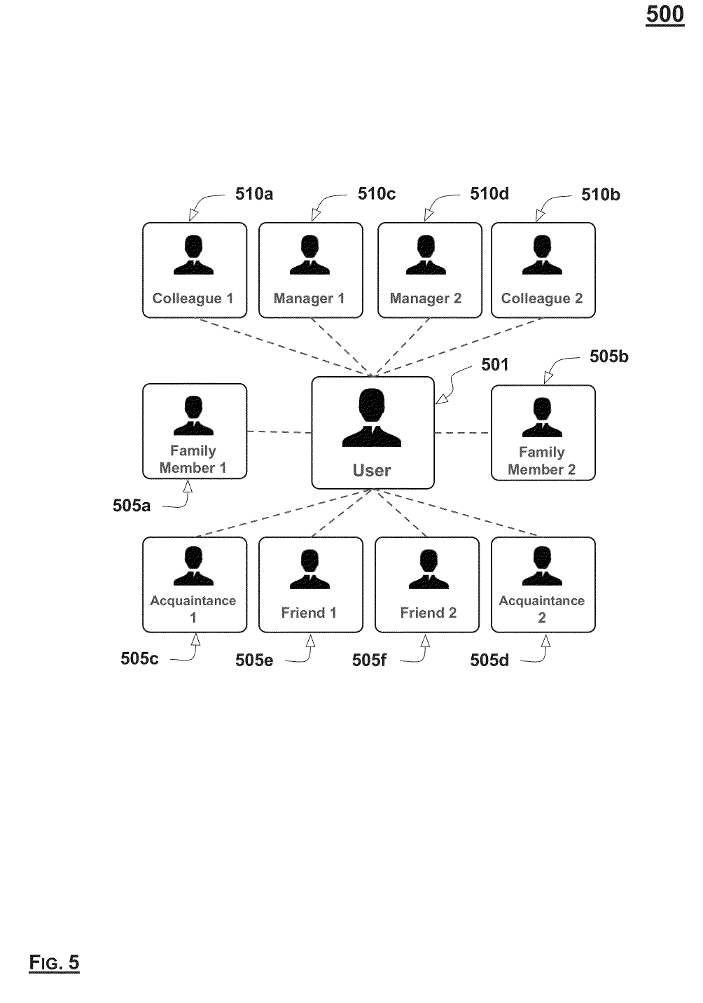

FIG. 5 shows an example social circle 500 of a user in some embodiments. The example social circle 500 shows a combination of pre-approved identification agents 505, as provided by the user 501 during registration, together with required identification agents 510 due to additional security policies that may be present for access to certain systems or methods, potentially of a certain organization. For some authentications, only some of the pre-approved authentication agents 505 may be selected, and may include family members, friends, and acquaintances. However, for certain authentications, potentially when there are more critical authentications for a given organization, additional authentication agents such as required identification agents 510 may be selected for an authentication process. These required identification agents may include colleagues, managers, designated individuals, government employees, etc.

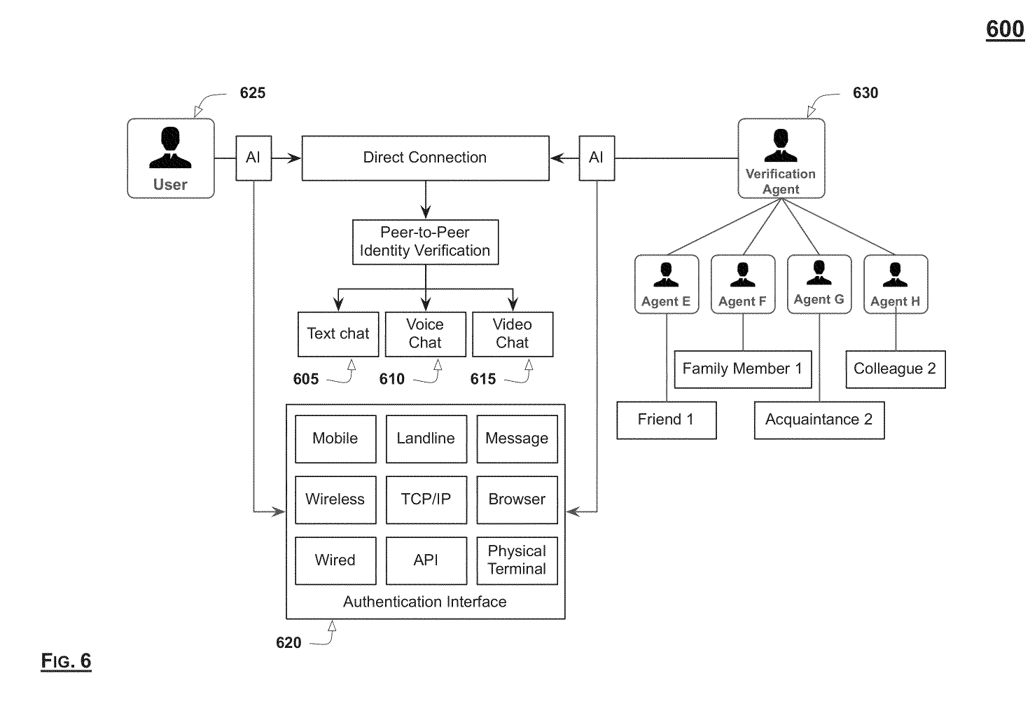

FIG. 6 shows potential implementations of authentication interface, and peer-to-peer verification link 600 facilitation done via text 605, voice 610, video chats 615 or any combination of these done via a range of connectivity interfaces 620 and communication protocols, such as, but not limited to, wired/wireless connections, TCP/IP, FTP, UDP, HTTP, SSH, OSI, CIP, etc. The user 625/authentication agent 630 facing hardware implementations may vary as long as they can match minimum connectivity/transmission, data capture requirements and can take the form of mobile devices, laptops, desktop computers, terminals, wearable devices, etc.

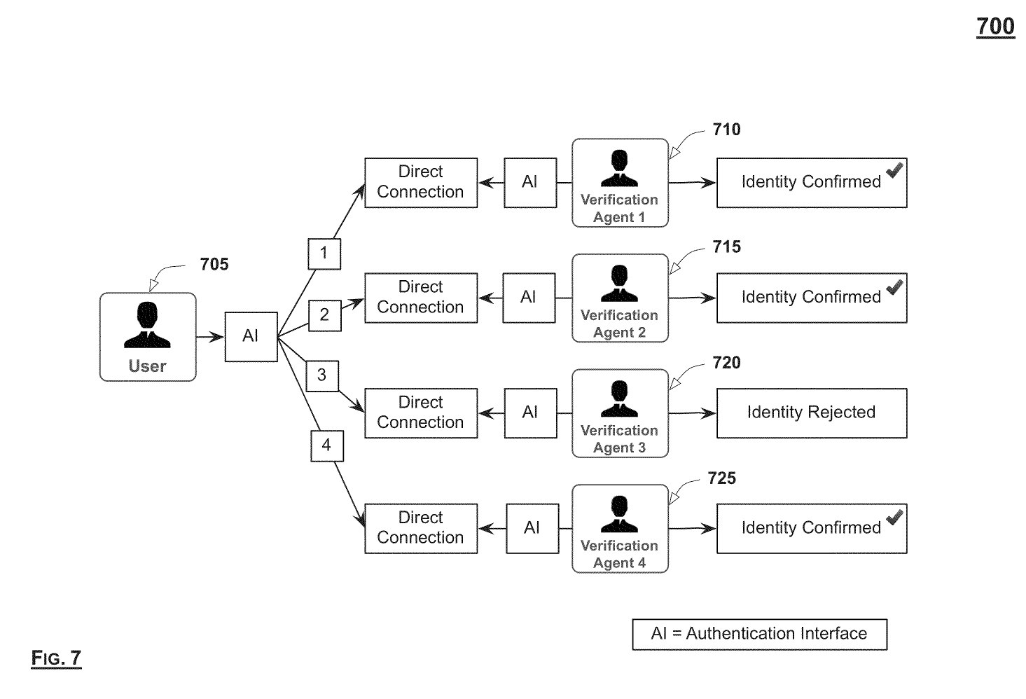

FIG. 7 shows an example 700 of dynamic real-time authentication agent rotation, where once the first (1) authentication session is complete between the user 705 and the first agent 710, the second session (2) is established with a different verification agent 715. The figure shows an example of a false-negative rejection by a verification agent 720, and consequent identity confirmation by the following verification agent 725.

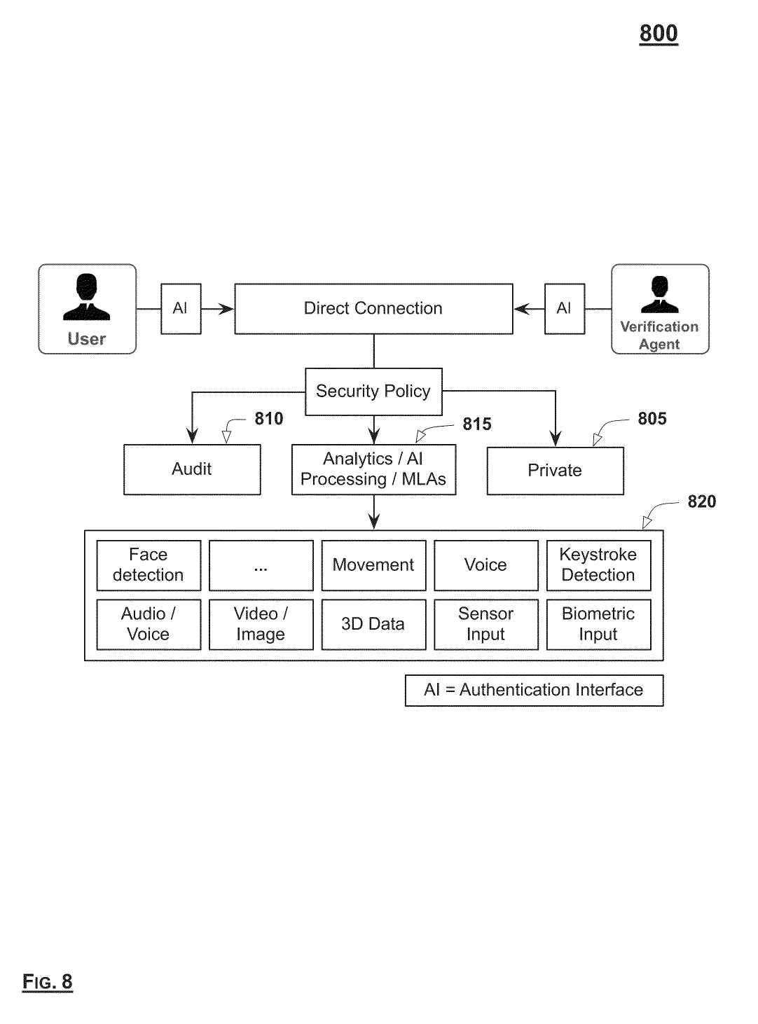

FIG. 8 shows an example of additional security policies incorporation 800 for implementations with security requirements, (1) allowing the entire authentication session to remain private 805, (2) allowing the entire session to be recorded for audit or monitored by third parties 810, (3) allowing additional analysis and processing to be performed by means of machine-learning algorithms (MLAs)/artificial intelligence (AI) methodologies 815 for additional levels of verification 820, including but not limited by voice, facial detection, movement, keystroke detection, three-dimensional data, sensory data, biometric data processing and analysis, among others.

In addition to peer-to-peer authentication methodology, the system might employ traditional machine-learning algorithms (MLAs) to analyze the contents of an authentication session for voice patterns, visual patterns, biometric parameters, body language, mimics, facial, iris, physical bone structure and 3D scans among a variety of data streams used for MLA recognition algorithm processing for additional user-verification steps, if necessary. The ability to process multiple streams (audio, video, dedicated 3D, dedicated biometric and other sensory inputs) among a variety of additional biometric signals as an added background verification process (pre-announced to the user) during each peer-to-peer authentication session will ensure constant updates of the secured database (if such database is required based on selected security policy), avoiding situations of stale data, resulting in false negatives. While this functionality is not necessary for peer-to-peer verification, as these technologies have been separately developed, certain organizations, institutions and business might require incorporation of these as added features for audit purposes in compliance with security requirements.

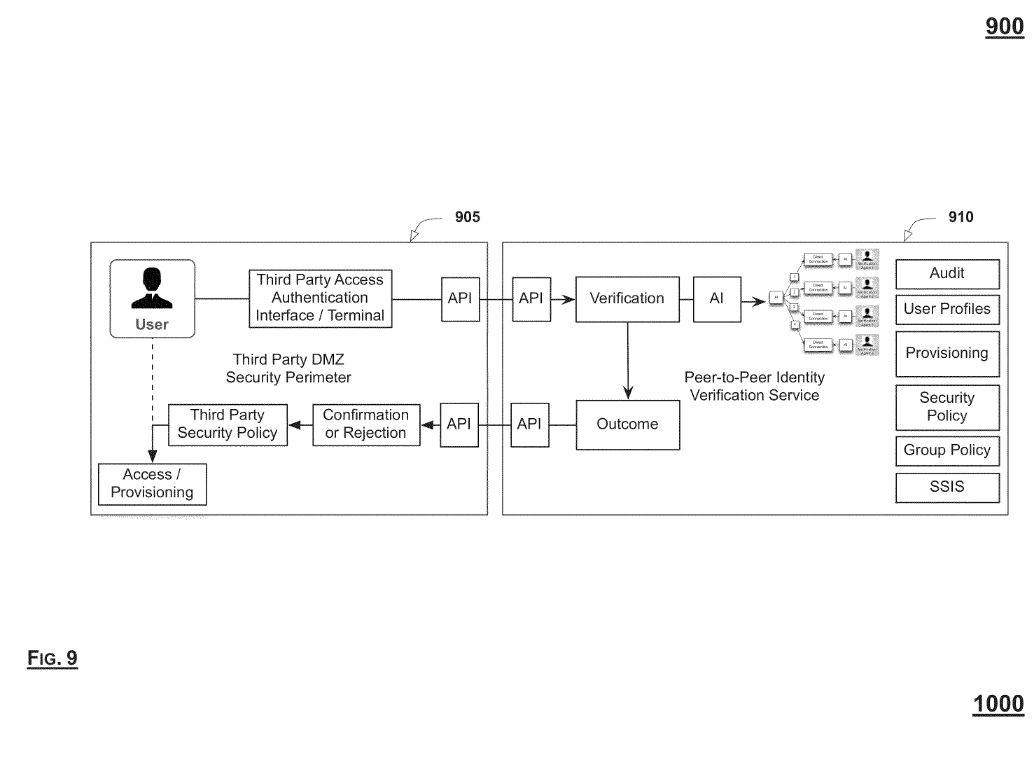

FIG. 9 shows an example of potential implementation 900 where a third party 905 uses the system 910 for user verification, expecting in return a result of the verification session provided via a standardized API.

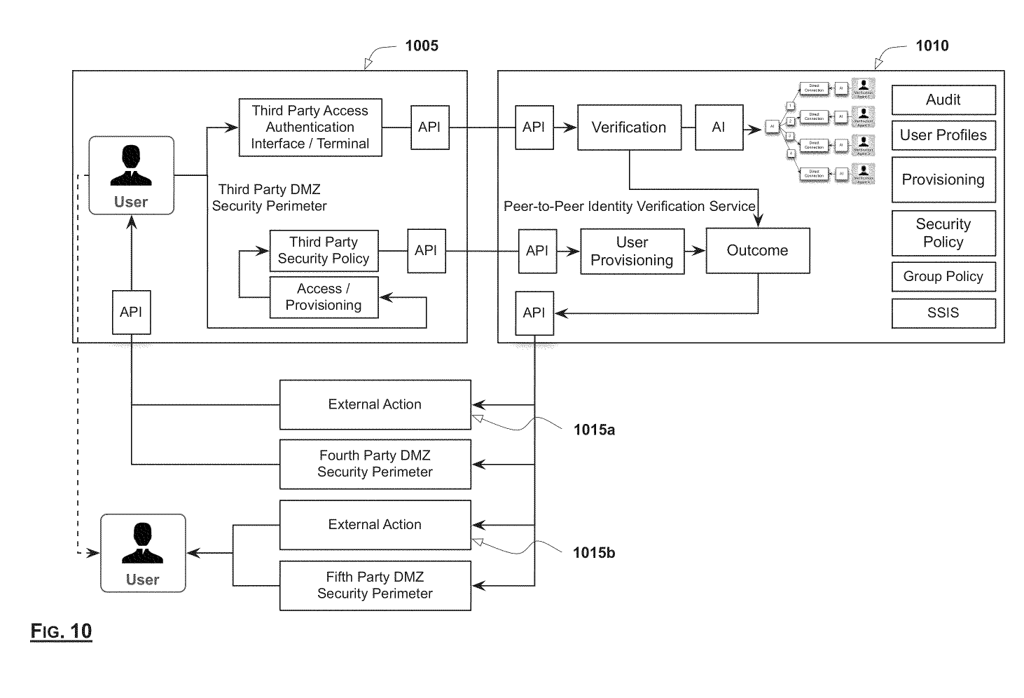

FIG. 10 shows an example of potential implementation 1000 where a third party 1005 uses the system 1010 for user verification and provision of additional services to user as per third party's user specific access/provisioning rules/security policy. In this instance, depending on the outcome of the verification session, the system will initiate a series of algorithms/processes/external actions 1015, potentially interacting with and engaging other external parties/services, or directly with the user outside of third party's DMZ (perimeter security network or sub-network).

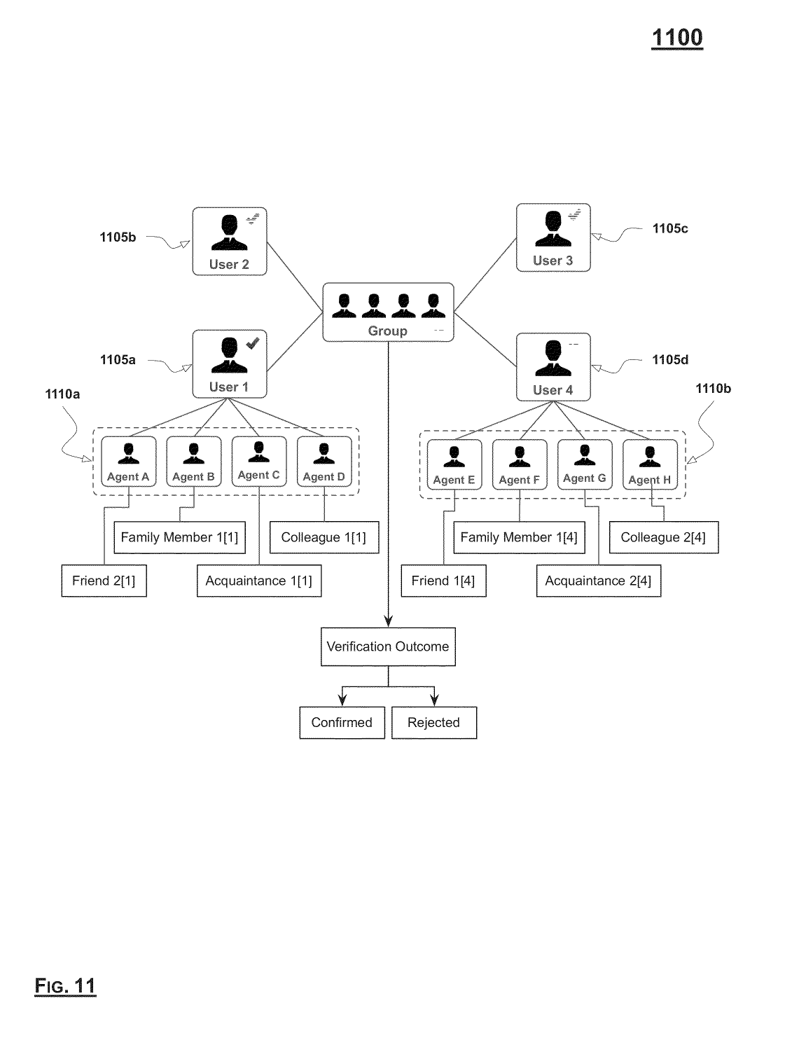

FIG. 11 shows an example 1100 of multi-user group verification, where each member 1105 of the group is separately verified by his/her respective group of verification agents 1110, based on each respective user's profile. Only after all of, or at least a predetermined portion of, the members of the group are verified does the system extend authentication/verification for access/provision of authorization/access.

Security Considerations

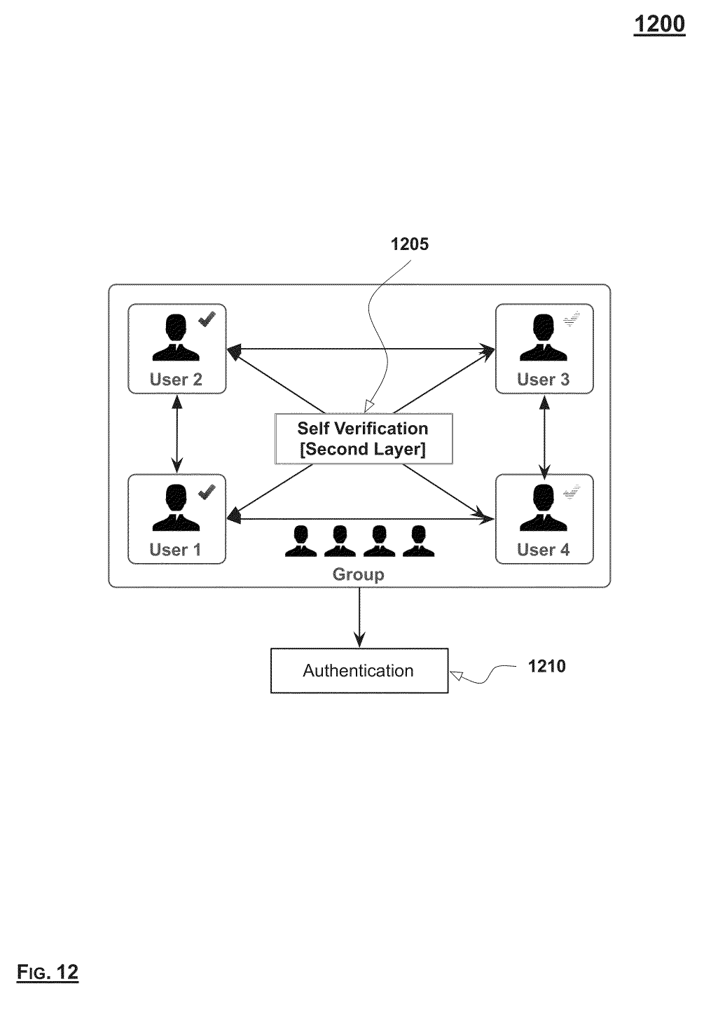

FIG. 12 shows an example 1200 of a multi-group user verification where after each respective member of the group was confirmed (FIG. 11), all or selected group members perform second layer of verification 1205, confirming either each other's identities or enabling additional features/options/functions, at which point the system provides authentication/verification for provision of authorization/access 1210 to a particular subset of options/features. Such group-level implementations are critical for environments where, for example, database access or production code changes can only be done (push, pull, get, etc.) when all team members are available live and provided respective confirmations in real time or close to real time. Such tight security measures might be necessary for access to protected customer data, production code updates, certain facilities, and/or additional/critical system functionality.

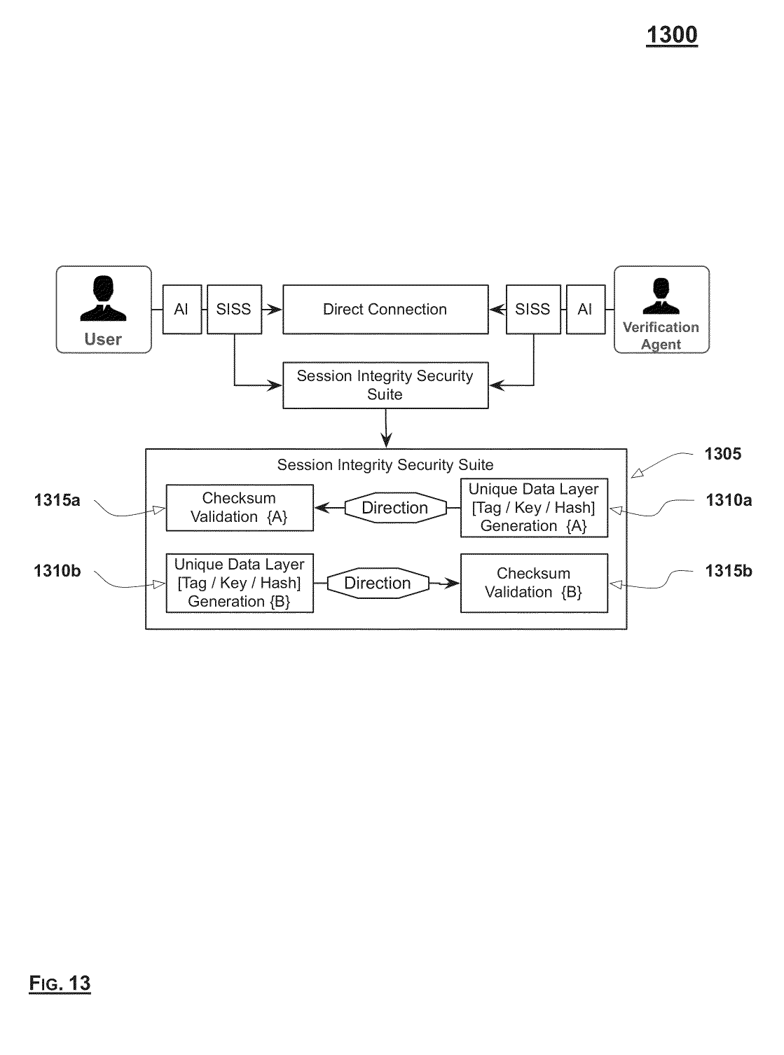

FIG. 13 shows an example 1300 incorporation of session integrity security suite 1305, generating a unique set of tag/key/hash/data mask combinations 1310 in each direction and providing comparison, delta calculation, validation either via checksum 1315 or other validation methodologies.

The system has the flexibility to incorporate additional data overlays, hashes, and tags for each respective bi-directional authentication session, while ensuring data overlays are unique in each direction (A->B≠B->A) and never repetitive from session to session. The system has the flexibility to keep a separate record of (1) generated data-overlays and (2) received/captured data-overlays to provide real-time checksum verification between the generated and received data overlays, minimizing man-in-the-middle intrusion potential. The ability to keep a separate record of data-overlays for audit purposes, while keeping authentication sessions private (not storing any personal details of the authentication session), provides additional privacy options to users choosing to ensure no private details are stored in applications where security policy provides such flexibility.

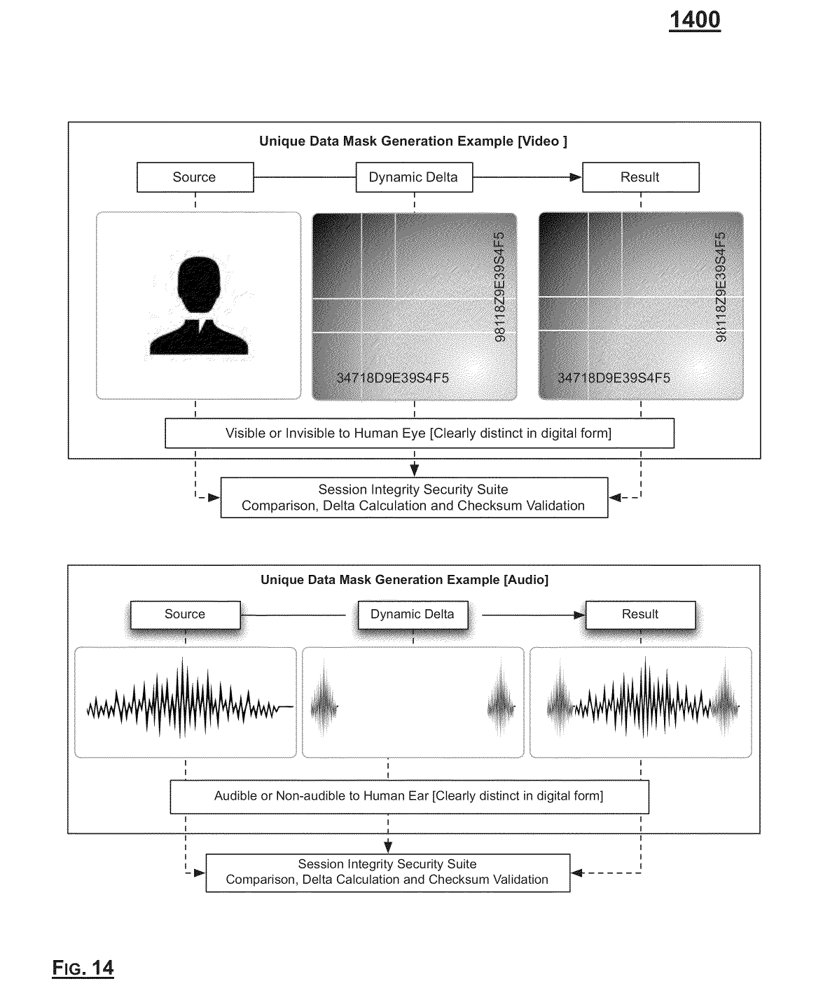

FIG. 14 shows an example 1400 of unique data mask/layer generation, whether visible or invisible to human eye, audible or non-audible to human ear, but clearly distinct in digital form.

Due to security concerns in corporate, federal, high-security environments, the security policy might require for the authentication agents (B) to have minimal ability to guess from what location or for what reasons the user (A) requires authentication. In these instances, the system has the ability to dynamically analyze and process the input from data/audio/video/sensory feeds of the user's (A) device and either remove completely or substitute any background data details (unnecessary from authentication standpoint) from which authentication agents might guess any details/reasons/purposes behind the authentication request.

The system might substitute the background details and/or incorporate additional data overlays (visible, or invisible, audible, or non-audible, while digitally distinct) with either randomly generated data or purposefully selected details to ensure connection integrity and minimize risks of intrusion attacks. In these instances, the system keeps records of both the original pre-processed data feed and the post-processed data feed for audit purposes. The same procedure of minimizing background details may equally be applicable in reverse to authentication agents themselves, if agents prefer not to reveal the details of their surroundings to the user during the verification session due to privacy concerns and/or security policy of the environments they might be in. The system provides two-way privacy controls to users and authentication agents, while ensuring data integrity necessary for valid verification session.

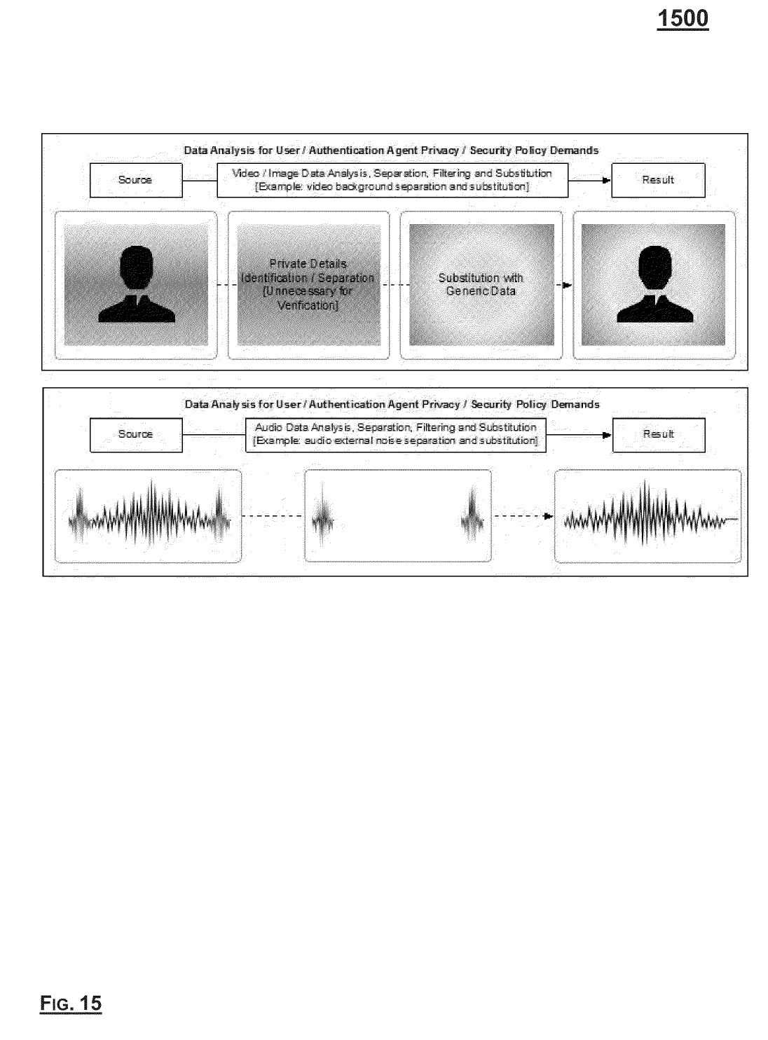

FIG. 15 shows an example 1500 of user/authentication agent privacy considerations that process and separate background (audio, video, etc.) details, unnecessary for user identity verification process, but are required to be kept private to ensure the privacy of each respective party (user and authentication agent). The system performs video/image/audio data analysis, separation, filtering and substitution necessary from privacy standpoints, without affecting the nature of interaction between user and respective verification agent.

Depending on specific applications, user choices, federal regulations, and legal considerations the authentication session between user and agent might be kept completely private without a need to record the content, while keeping granular record of the session itself (time, length, endpoints, addresses, anomalies, etc.) for audit purposes, whereas in other instances it might have to be recorded and securely stored for a defined period of time for audit purposes.

Robustness and Power of this Method and Process Against Intrusions and Conspiracies Stemming from Rogue Elements

Combining both traditional social connections (family, friends, colleagues) with required security (corporate, management) members further reduces false positives (intrusions) in high-security situations where a management/supervisor level employee acts as a rogue element providing system access via credentials of a lower-ranked employee to a third party. In this instance, the third party acts as an intruder using credentials of a lower-level employee (user) while receiving real time authorization by a rogue supervisor, leveraging the system where parallel two-user/multi-tier authentication is required for access. In this instance, even though an intruder has access to credentials of a user (lower-level employee) and has authorization access from the supervisor, an access will not be granted to the intruder as he/she will fail authentication by members of the user's social circle (family, friends, colleagues).

Leveraging the fact that members of subject's social circle are acting as verification agents evaluating the user's identity, the amount of common factors between any {user:verification-agent} pair exceeds any potential number of keys a user might have to remember. The common identification factors are naturally updated on a daily basis as the user continues to engage in his/her social engagements with family, friends and colleagues. The current system does not require any specific personal data points to be memorized by a user, or be stored in a database for matching by a service provider. Any storage of personal details, or answers to personal security questions, subject the service provider to additional intrusion risks, and, if there is a breach, expose user's personal details to intrusion via a different third-party service provider, where the user had previously provided the same answers to the security questions, providing additional vectors of attack. Regardless of how personal or rare these questions are, it takes one security breach at any of the multiple providers, to expose user's personal details to security breaches at other vendors.

Nature of Peer-to-Peer Verification Process, Method and Service

Peer-to-peer verification broadens and deepens quality of identification and user verification by increasing quantity and precision of identification factors between the subject and verification agent, strengthening the security by avoiding stale data, as the social interactions between subject and verification agent are naturally updated (in human memories—neuronal synapses) with the flow of time. The evolving nature of data points between subject and verification agent reduces the risk to a service-provider as much as to the end user, as personal details do not have to be stored due the fact that verification takes place in a peer-to-peer fashion. Consequently, users do not have to remember any specific pre-agreed sequences or pass phrases, since the memories, and mutual dynamics between an individual user and a verifying agent, such as gestures, emotions and feelings from mutual experiences substitute traditional key/pass/public/private combinations in a natural way. Relying on natural memories, behaviors and interaction patterns of individuals provides a multi-dimensional space of parameters and expressions that is more challenging to recreate or replicate without being exposed.

As a result, users do not have to remember multiple sequences that have to be cycled over time. The fact that human memory tends to remember the most recent events with the most clarity, the current system relies on a natural refresh cycle of the authentication data points between a user and an agent, while ensuring data validity and accuracy, as both members will naturally tend to remember memories from the most recent past. In case there is a concern for potential identity mismatch, since an authentication session takes place in real time or close to real time, it is much quicker for the authentication agent to verify the user's identity further by referencing some of the older memories/events of mutual relevance.

Ongoing Quantitative and Qualitative Assessment and Dynamic Adaptation of Authentication Session Parameters and Security Requirements

The system dynamically adjusts for situations in which any particular authentication session results in a false negative result, where an authentication agent reverts with a rejection, not being able to confirm the user's identity though the real identity does match the user. An authentication agent might revert with a rejection to an authentication session for multiple temporary reasons, including but not limited to lack of attention, sleepiness, pranks, bad mood, personal problems, anger, external environmental factors (medications, intoxication, etc.). In these situations, the system will record failed authentication attempt, but will let another opportunity for user's identity to be verified with a different authentication agent. The system allows defining the number of failed attempts before preventing another authentication attempt via the same authentication interface for a certain period of time, while initiating additional procedures to notify the user and selected members of user's social circle of the potential authentication threat.

The system provides a secure protocol for a user's social circle of verification agents to be updated over time, depending on mutual dynamics between the user and verification agents with the flow of time as social connections appear and disappear, and/or strengthen or weaken over time.

Infinite Natural Depth and Data Granularity of Verification Parameters

As an added benefit, the peer-to-peer verification nature of this identity verification process provides an additional safety margin as one's social circle has a much deeper knowledge of the user's location, personal habits, traditions, actions and behaviors which will facilitate identification of an anomaly and prevent false positives (intrusion). Vice versa, deeper understanding of a user's recent past, by authentication agents, minimizes false negatives in situations where a user's behavior might deviate from the norm either due to travel, extra added work, lack of sleep, personal situations, change in appearance or behavior for natural reasons (illnesses, surgeries, haircuts/tanning/style changes, medications, etc.), that might affect traditional identity verification methodologies. In these situations authentication agents are most likely to be aware of the reasons behind these either short-term or permanent fluctuations in a user's appearance/behavior, and will be much more receptive in deciphering possible explanations a user might provide.

One advantage of peer-to-peer identity verification workflow may be the minimal amount of information stored by the service providers. In the event of targeted attack and consequent security breach, even if the information could be decrypted from salted hashes, the only details available would be contact details of members of one's social circle. With the prevalence of social networks and the connectivity trail users leave behind in their day-to-day activity these data points (user's social connections and their contact details) are already publicly available or can be recreated with a relative ease for a committed intruder or an interested party.

Even if an intruder gains access to these contact details the system would not let the intruder use these details for actual verification and consequent system access, as access relies on peer-to-peer approval and not on any of the details stored by the service-provider (most likely available in public anyway). In some implementations, the systems and methods do not require storage of personal details (first name, last name, DOB, etc.), though such an option is available; the only minimal requirement is the contact details (some form of communication channel) for the vetted members of one's social circle. Not storing personal details of the underlying users (if necessary), but storing just one's chosen and vetted social connections (verifying agents) with respective contact details, provides additional anonymity, as the connection data can be stored without a need to store person-specific identification information.

Additional Potential Advantage: No Privacy Requirement

One of the differentiating advantages of some embodiments may lie in the fact that the authentication sessions can be held in public, as the user is not required to exchange any confidential details with an authentication agent, unless an authentication agent specifically asks for it. The nature of live interaction, between individuals who have known each other for an extended period of time, is that the inherent meanings behind words and expressions can be portrayed in live conversation (via text, voice, expressions, visual movements, etc.) without a need for individuals to exchange confidential details about each other; hence authentication sessions can take place in the public domain.

Another possible additional advantage of such a peer-to-peer authentication mechanism, allowing for additional checks against false negative man-in-the-middle intrusion attempts, such as trying to record/replay/recreate one's identity based on previous sessions, for example, may be that each authentication session between user and the same authentication agent will never be the same, since these sessions can take place at any point of time, subject to broader environmental developments surrounding us; hence authentication details are naturally updated.

Communication Channel Data Processing for Privacy Considerations

If the authentication session takes place in a public domain and is subject to eavesdropping, the system provides a flexibility to minimize the exposure of an authentication agent's (B) identity to the public domain of the environment in which user (A) resides at the moment of the authentication session. For example, while maintaining the connection, user (A) can choose not to show the video feed of the verification agent (B) on the screen of the user's authentication device, minimizing the exposure of verification agent's identity. At the same time, verification agent (B) continues to receive full audio, video, textual and sensory inputs from the user's end. The same functionality is available for verification agent (B), in a public situation, who prefers to provide additional privacy to user A, while ensuring that the verification agent has enough data points available necessary to validate the user identification session.

The system may ensure that the authentication agents are not made aware of the user's purposes beyond the authentication request. A quid-pro-quo incentive system ensures integrity of peer-to-peer verification. The system incorporates a suite of initial user-validation steps to minimize potential for abuse by third-parties and intruders, for example, trying to perform distributed attacks by attempting to issue multiple authentication requests on behalf of a specific user trying to disturb a user's underlying social circle.

Additional Implementation for Multi-User Group Environments

The functionality of the system further extends to group environments where security measures require multiple team members to be present to facilitate access or extend additional functionality. In multi-member group interactions, verified participants can verify identities of other members in real time to allow additional verification prior to provision of access. Once respective identities have been verified for all members of the team, the system can automatically provide confirmation and extend authentication for access. This functionality can be applicable, for example, to extending security for systems where, for example, database access, production code changes or additional functionality can only be provided after all team members are available, their identities have been verified as per security policy and each member provided confirmations for the system to provide further authentication access to the entire group or a subset of the group. Use of standardized APIs for this purpose avoids situations where remotely connected intruders are able to utilize user credentials to gain unauthorized access to production systems/databases, even if intruders gain parallel access to multiple systems in real-time. Having real-time user verification of in-group environments, as well as intra-group user/access confirmations as a second layer of verification, adds an additional security barrier against intrusion attacks.

Standardized API

The system provides a standardized application-processing interface (API) for external access, usage and implementation. The system provides flexibility (1) for third parties to use it solely for the identity verification purposes of the underlying users (verification subjects), resulting in standardized and encrypted responses on the outcome of the identity verification sessions, (2) for third parties to rely on the system to provide directly to users (verification subjects) specific predefined or dynamically defined data sets, links, access and control, additional functionality to verification subjects, (3) for third parties to rely on the system to interact and render services between users and fourth parties, or a combination of the above.

Dynamic Analytics, Processing, and Authentication Security Adjustments

For each respective authentication session the system dynamically analyzes a variety of input parameters to assign a trustworthiness score to each data point and an authentication agent decision (whether confirmation or rejection). For example, depending on the time of the day, there might be significant variability in incoming sensory data used for conditional matching, as well as the ability of a verification agent to be effective in making a correct verification decision. As an example, the system would rather avoid reaching out to verification agents who are in a time zone where it is the middle of the night, and would rather reach out to verification agents who are awake and likely to be more effective in decision-making. However, if the system has no choice but to reach out to a verification agent in the middle of the night, it will assign a lower trustworthiness score to the result submitted by that particular verification agent. Similar logic applies to any external data points provided in machine-readable format, as any data is subject to variability, cyclicality and pattern-like behavior that should be dynamically accounted for when dealing with data deviations.

Parameter Conditionality Based on External Authentication Inputs

In another embodiment, the system and process facilitate not only the authentication of identity but provide the ability for the verification agents to verify additional conditionality associated with a user being verified. For example, the system might not only request to verify that the user's identity matches, but also that a user is located at a certain location, at a certain time point, slept for eight hours the night before, has blood with an alcohol or pharmaceutical content below a certain level, has a blood chemical composition that matches a certain profile, is well rested, among a variety of other potential conditions a user might have to be required to match. This is particularly relevant in applications where additional conditions are critical for further authentication and access. For example, the system will ensure for public transport operators (drivers, pilots, etc.) to match certain health checks in addition to verifying their identity prior to providing access to operation of public transport machinery or performance of other functions.

In this embodiment, the system may or may not use predefined verification agents for additional conditionality checks; for example, a border patrol agent may verify additional parameters, or a delivery man may verify that the user is physically located in front of the house, performing a specific task required to match the condition of the verification.

In this embodiment, additional parameters for conditionality checks may be provided and based on inputs from previously vetted verification agents (assigned to user's profile) as well as randomly selected verification agents whom the user might have not known before, unrelated third parties, or other services and devices.

External Agents Outside of User's Established Social Circle

In this embodiment, the system will dynamically identify potential verification agents, systems or processes based on a certain set of rules and assign an agent whom a user might have not known in the past to verify that the user in question satisfies a certain condition, such as being in a certain location, being awake, doing a certain task, as simple examples. These individuals or third parties might not know this particular user in person, but by matching certain criteria or a set of conditions, such as being in the same location at the same time, external unrelated individuals and systems might provide additional conditional inputs for overall verification purposes. Other systems and processes might act as partial verification agents to provide additional data points to the service to assist in a decision as to whether these parameters match the conditional requirements for user verification.

As a potential case, it might happen on random occasion that both the user and one of the dynamically selected verification agents might be in direct proximity to each other and it will not take more than a second for the verification agent to confirm the user's identity even without requiring establishing a direct communication link between the two as they are already next to each other and do not need to be connected via a separate communication interface. While in that instance establishing the actual live-time connection might not be necessary as in reality it is redundant, the service will guarantee the authenticity of verification and ultimate authentication and authorization provisioning; hence this process will still be interacting with each respective pair of individuals.

Collective Wisdom

While each verification agent might provide its respective input or data point to the service, it is the aggregate intelligence of all data points collected securely by the service across a variety of sources via a variety of public and private communication channels, cross-matched against the predefined set of authentication rules and conditions for each respective application, that results in the high reliability and trustworthiness of the authentication decision and the underlying logic.

Communication Value Assignment|Verification Guardian Incentives Messaging Session Pricing Mechanism

In an age where we are constantly bombarded with multiple data streams, constituting different kinds of stimuli and feedback (i.e., visual, auditory, haptic, etc.), all of these communication streams may require attention, physical and mental processing, and in many instances some sort of response. From time-to-time these interactions may result in stimulatory overload where person's capacity to process large quantities of information per unit of time may be exceeded. This results in discomfort, loss of productivity and other consequences stemming from stimulatory overload. While many solutions exist focused on filtering spam and other unnecessary interactions, the current invention targets the situations where the amount of healthy or otherwise necessary non-spam communications/data messaging becomes too excessive for the user to process.

In scenarios where two or more parties are about to establish a communication session, whether by means of messaging, audio (call), video communication session or other type of data messaging exchange, if one party is experiencing a stimulatory overload, that party will most likely not be able to participate in the communication session. This may consequently result in the other party, or multiple parties, not being able to communicate, resulting in loss of productivity and general dissatisfaction from the experience for all parties involved.

The more common ways of dealing with data messaging sensory overload today may include all or nothing solutions, such as turning off the device/service/source of stimuli, or enabling aggressive filtering profiles that result in significant reduction of sensory stimuli/notifications. However, these solutions may prevent urgent and important communications from being provided to the user, even though the user would likely desire for that particular message/content to be provided to them immediately. Additionally, in many instances the user may not be able to predict the importance of the communication because the source may not be immediately recognizable or previously known to the user.

In an example situation, consider three parties: users A, B, and C. User A enables an aggressive filtering profile that prevents any outside communications except those from the top ten most common parties of user A's address book. Because user B is part of user A's top ten list, user B's communication would go through user A's filter and user A will receive the communication in due course. However, user C has never interacted with user A before and therefore user A's filter will block any communication from user C, regardless of the nature/urgency of the communication. Unfortunately, there may be messages of import or urgency which user A would likely to receive in due course even though they have never interacted with user C. As an example, if user C wanted to inform user A of the family emergency taking place with a member of user A's family, it would be beneficial and expedient for all parties involved for the communication from user C to go through the filter to user A in light of the urgent nature of the communication.

To deal with this situation, the current invention may assigns priority/urgency values to each communication message, regardless of whether two parties know each other beforehand. Each party may then assign priority/urgency values to each outbound communication message, and filter each inbound communication message by the priority number assigned to it by the source of the communication, or by the intermediary party/facilitator that may be directly involved or responsible for processing of the message (such as a 911 emergency call center). However, a key feature of many embodiments herein may be that both the originator/sender and recipient of the message/communication have the ability to assign priority value to outbound/inbound communication traffic. The priority value may include multiple data points aggregated from multiple sources, as an example, a value assigned by the sender, a value assigned by 911 center, a value assigned by the security guard on the physical premise where emergency takes places, a value assigned by the heat sensor of the location where emergency takes place, a value assigned by closed circuit cameras monitoring an entrance to the facility, and/or a value assigned by heart monitor of an individual involved in the emergency. When all of the above data points are aggregated into a priority/urgency number assigned to the communication type, user A's preset threshold may allow for the message to be passed through without delay.

Even for the parties that may have known each other beforehand, their communications would typically contain a variety of messages with a varied degree of priority and urgency. In situations where user A is experiencing communication overload, it would've been beneficial for user B to be confident that a message with a higher assigned priority number did get through user A's filter, whereas a message with a lower priority could be delayed but would be received by user A, whenever user A lowered the threshold value once user A is no longer experiencing communication overload.

Embodiments herein may allow the receiver of a communication to assign threshold values to each respective source/sender of communication and provide a wide degree of conditionality to dynamically change the threshold depending on other external conditions, such as time of the day, day of the week/month/year, location, state of the device, battery level, etc.

Embodiments herein may also allow the receiver of a communication to assign threshold value applicable to all incoming communications, irrespective of the user, and allow only communications exceeding certain threshold value, or meeting certain sets of conditions, to go through without delay, while the other might be postponed until certain condition is met later in time. A wide degree of conditionality may be allowed to dynamically change the threshold depending on other external conditions, such as time of the day, location, battery level, etc.

Embodiments herein may also allow senders of the communications to assign priority/urgency number to each message. Some embodiments may also allow a sender to combine and include multiple data points received from other third parties/providers in an priority/urgency variable for a particular message, even though other third parties are not directly involved in the messaging between sender and receiver. Other third parties may be involved by virtue of the nature of data content that is being provided by the sender to the receiver and that may be the reason to include at least a portion of their inputs into the priority/urgency number, as points of support/reference.

In one embodiment, the source of the communication (user B) may also assign a monetary value to a message sent to user A. User A, after seeing the monetary value assigned to the message, may decide to read it. If after reading the message received from user B, user A agrees that the communication was truly urgent, and not spam for instance, user B would not be charged the assigned monetary value of the transaction. However, if the message was spam or otherwise unimportant, and user A no longer wants to receive communications of such type, user A can choose either to increase filtering bar for user B or accept the assigned monetary value by user B. As a result user B will be notified that the communication wasn't worth the urgency or assigned monetary value, and user B may be charged the assigned monetary value.

As a result over time the market may discover the proper price and value of the time a person spends reading messages from unknown parties, and the known parties may learn over time the type of messages to send and the right urgency number and/or monetary value to assign to it. Importantly each respective communication pair may find the right equilibrium between function and “noise” of the communication message. Not only may this result in clearer communication, but may force the nature of the content to become more focused, succinct, better matching mutual expectations of sender and receiver over time.

While the above examples use monetary price for exemplary purposes, in reality any cost-based system can be used to associate the cost of message/transaction with the priority/urgency value of the content. In addition it can integrate proof-of-work systems, where sender agrees to pay a cost in the form of computational cost. However, in this instance, the type of computation, both input and output, can be defined by the intended recipient of the communication. Importantly, both the sender and receiver may be the ones responsible for setting up and adjusting respective priority/urgency values and filtering thresholds.

The process described above is applicable to multiple types of communication, but particularly relevant and applicable to the communication sessions involved in verification procedures described herein, where multiple parties (guardians/agents) are used for verification of a principal/user. By nature of the parties and objectives involved, the majority may be considered non-spam communication, however some users might use the system more often than others, whereas others may have to adjust the notification thresholds based on their lesser usage of the system.

For the purpose of this exemplary explanation, we use a simple 0-10 priority/urgency scale, however in real application the scale may be broader, comprising other variables, data points, and/or conditions. In an example, one guardian may want to receive verification requests from one specific principal only in urgent situations [above 8], whereas for another principal who happens to be a family member, and for example, who doesn't use the system as often, would want to accept nearly all verification requests [0]. For yet another principal, who happens to be a work colleague, the guardian may only want to accept work-related verification requests [above 4|additional condition: work-only|additional condition: no personal requests].

While it is common to have binary outcomes from message filtering, meaning that a message either exceeds the threshold value and passes to the recipient or is below the threshold and gets blocked, results can also be subject to conditionality based on a time-variable and/or priority/urgency variables provided by both senders and recipients. This may mean that while in some situations the initial message may not be immediately passed through to the recipient because its priority order does not match a threshold value, the recipient may still receive it at later point of time when certain conditions have changed. These conditions may include such variables as the flow of time (such as time-to-live|expiration time), or because the recipient has lowered/relaxed the threshold policy value. Such time-variable assignment and message delivery control reduces number of blocked messages, while ensures optimal delivery at times/conditions most appropriate to the recipient. This increases the utility to both to the sender and recipient as the message may be actually delivered at a time point under the conditions where the recipient is best positioned to capture and process the content of the message. One of the differentiating factors resulting in value added by this approach is that a message may only be delivered under a set of conditions mutually agreed by sender and recipient, even though those conditions were set up in advance independently of each other. Some embodiments may also allow for integration of an intermediary or a set of intermediaries that will facilitate discovery and matching of the condition set between sender and recipient.

The mutually agreeable set of conditions will evolve over time and will actually improve as both recipient and sender learn the type (format, length, language, etc.), content, and exact set of conditions and/or assigned priority variables which are most appropriate for effective communication between recipient and sender. As each recipient/sender pair will have their own respective value set of what they would consider an effective communication and prioritization—embodiments herein foster discovery of the unique set of conditions for each recipient/sender pair, resulting in clearer, more focused and precise communication and importantly processing of the message by the recipient. Typically it is the recipient, who for a variety of reasons, doesn't process the communication data packet in a time frame expected by the sender. Embodiments herein introduce a way to discover optimal communication patterns by means of priority optimization over time.

### Example Embodiments and Features

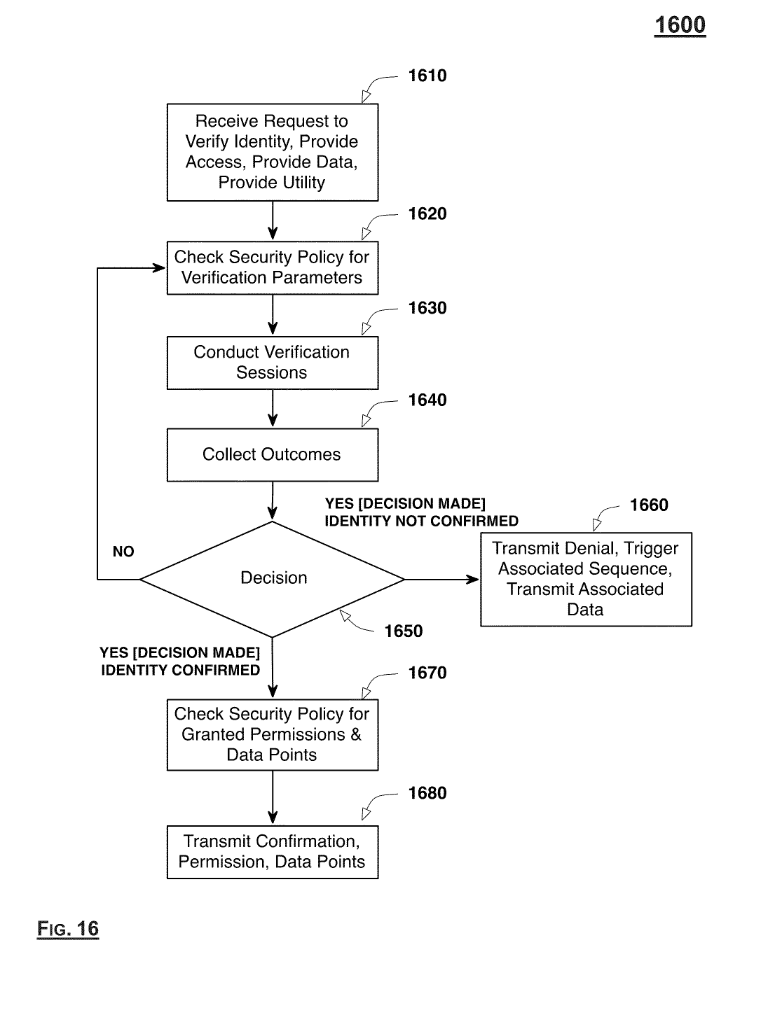

FIG. 16 further describes the processes discussed above. Process 1600 is a method for verifying the identity of a party (also referred to as “authenticating” a party or “principal”). At block 1610, a system receives a request to verify the identity of the principal. The request may come from a party seeking to verify their own identity at the request of others, or may come from the other party which seeks to ensure the party is who they say they are. If the user is requesting authentication, the user may also be required to specify a recipient for any resulting decision of the authentication process. If a third party is requesting authentication, the user may be specifically informed of what third party is requesting authentication prior to principal-guardian sessions commencing as described below.

While in the previous application the principal is often referred to as the “user” and the guardians are often referred to as “authentication agents,” these terms are interchangeable. It will be apparent to those of skill in the art after reading the previous application and the instant application that other terms are used interchangeably to describe similar or the same elements in various embodiments.

At block 1620, the system checks a security policy for what parameters will be applied to the identity verification, as previously defined by the party requesting authentication. For example, a corporate entity using the system to verify identities and thereby restrict access to physical or virtual resources may arrange/define a security policy which specifies variables used by the system to determine how stringently to verify a particular party's identity. As a further example, a government entity may arrange/define a different policy to restrict access to similar or different resources.

With reference to the previous application, the system may determine from the security policy that for a certain user/principal, or for a certain defined class of users/principals, that certain parameters must be met for a given principal to be verified. These parameters will be further discussed below, but relate to what results are required from one or more verification sessions conducted between the principal and guardians.

At block 1630, the system, in cooperation with other sub-systems or clients, causes the verification sessions to occur between the principal and selected guardians. The guardians are selected from a predefined set of guardians specified by at least the principal, the party attempting to verify the identity of the principal, or some combination thereof. Such guardians may be defined at registration, and/or may be supplemented over time by either the principal or the party represented by the security policy.

The security policy specifies how many guardians are randomly selected, within any additionally specified guidelines, from the predefined set. In some embodiments, the number of guardians selected may depend on characteristics of the selected guardians (i.e., fewer guardians may be necessary where the particular guardians selected are recognized as more trustworthy than other guardians).

The sub-systems or client can be any device capable of facilitating a link between the principal and guardians. Merely by way of example, the device may be a mobile device or phone, or a point-of-sale like terminal at a checkpoint where identity verification is necessary. In some cases, if a point-of-sale like terminal is out of order, a mobile device or phone of the principal may step in to provide the functionality of the point-of-sale like terminal.

The verification sessions may be conducted via a communication link between the principal and the guardian. The communication link may be visual or audial, and may be provided by an associated system, possibly facilitated by a third party service provider. During the communication link, the principal and guardian will be allowed to interact and communicate for a limited or unlimited amount of time until one of three results is reached: the guardian confirms the identity of the principal (referred to herein as a positive identification or “1” result); the guardian makes no determination regarding the identity of the principal (for example, time runs out or communication ceases with no decision; referred to herein as a no-decision or “0” result); or the guardian confirms the principal is not who they purport to be (referred to herein as a negative verification or “−1” result).

The guardians determine if the principal is who they say they are based on their prior knowledge and experience of interaction with the principal. The principal's appearance, voice, and knowledge, possibly regarding shared experiences with the guardian, may allow the guardian to determine if the principal is the person they are purporting to be.

The individual verification sessions can be queued up by the system is such a manner to expedite the entire process for the principal and minimize the intrusion into guardians' time and affairs. For example, the system may initiate a verification session between the principal and a first selected guardian as soon as possible after the verification request is received, and while that session is being conducted, indicate to the next guardian that a verification session is incoming and/or will begin shortly. This process may continue for all selected guardians.

When a session request is sent to a client device of a guardian, the request may cause the device to query the guardian and ask them if the guardian is willing to participate. A certain amount of time may be allocated to the user to accept or deny the participation request. Upon time-out, a null result (0) may be returned to the system. Some security policies may require participation of some guardians, especially those specified by the entity establishing the security policy, and the allocated time may merely be provided to allow the guardian to prepare for the session. A guardian's willingness to participate in authentication sessions may change the weight accorded that guardian's confirmations to the system.

Unique Signature Generation|Black Box Flight Data Verification Session Recording

During authentication sessions, client application software and/or hardware, both for guardians and principals, may record operating characteristics and events which occur during the authentication sessions. To further strengthen the authentication process, the data streams of the associated sensory inputs may be captured and stored both prior to and after the actual authentication session. The recorded data streams are comprised of sensory inputs based on user interactions such as, for example, gestural interaction via direct touch (with associated two-dimensional coordinates, pressure inputs and their derivatives), gesture inputs (with associated two- or three-dimensional coordinates and their derivatives), audio, video, image, proximity as well as more general input data streams from sensors such as, but not limited by motion sensor, accelerometer, gyroscope, location, temperature, moisture, altitude, ambient pressure and light, chemical and physical sensors (pH level, gas composition, etc.). A combination of these data traces will result in unique signature generated for each verification session, creating longer term patterns which may be used in creating additional intrusion detection measures.

In addition, to increase intrusion detection attempts, each client device, for both guardians and principals, may capture audio, video and textual inputs of the actual verification session to be compared against the similar data points captured from within the core server of the process, facilitating the communication between the devices. In some instances, the security policy may allow or instruct the process to do so, while in other situations it may be not allowed or elected not to be used by end user.

This recorded information may be transmitted with the authentication results, or stored and provided to the system at a later time, perhaps when bandwidth is more freely available, and/or by means of different communication pathways, and/or by means of different encryption mechanism to reduce chances of man-in-the-middle attacks, thereby increasing the chances of detecting any intrusion. Importantly, this “flight data” package may be transmitted retrospectively (at any random time or a time-synced moment) to the system core, separate from when the initial verification session outcome is transferred to the core.

Relating this airplane-like “black box flight data recorder” information to positive, negative, or no-decision outcomes of each respective verification session by each guardian may provide insight into system processes, help detect intrusion attempts, and further impact the relative trustworthiness factor of each verification session. This information may also be used to supplement the authentication decision process, or may allow for the decision making process and/or application/system software/hardware to be refined so fewer false-positive or false-negative results are returned during future authentication processes.

At block 1640, outcomes from the verifications sessions are collected and processed according the security policy. The security policy determines what weight any one particular data point will have on a final determination. The security policy also specifies any conditions that may override the cumulative indication which the data points provide.

The security policy may assign both weight factors and trust factors to any specific verification session/guardian. In some embodiments, the weight factor will be equal across all verification sessions for an authentication attempt, while in other embodiments the weight factor can otherwise be distributed, but will sum to 100% for all verification sessions. A guardian's weight factor may be based on one or more factors, such as time of day, day of the week, day of the month, month of the year, relationship to the user/principal, relationship to the party requesting authentication, relationship to the asset for which access may be provided upon successful authentication, and/or any other potential component that might have statistically significant impact on the outcome of the verification session. The trust factor can be between 0% and 100% for a particular session/guardian. A guardian's trust factor may be based on one or more factors, such as time of day, day of the week, day of the month, month of the year, relationship to the user/principal, relationship to the party requesting authentication, relationship to the asset for which access may be provided upon successful authentication, weather (for example, at the location of the principal, guardian, party requesting authentication, and/or the asset to which access will be provided upon successful authentication), historical false-positive and false-negative hit rates, historical no-decisions, any other historical authentication session data, and/or any other potential component that might have statistically significant impact on the outcome of the verification session. The product of the weight factor, the trust factor, and the result provided by the guardian decision (e.g., 1, 0, −1) provides the weighted result for the verification session.

In some embodiments the trust factor for any particular guardian may exceed 100%, possibly by a multiple, providing for a potential 200%, 300%, etc. trust factor. This could impact the decision making process by necessitating that multiple other guardians provide adverse determinations to the particular guardian to override a result consistent with the particular guardian's decision to authenticate or not authenticate the principal. Alternatively, such a particular guardian could also have the ability, by virtue of their high trust factor, to override the decision of multiple other guardians with lower trust factors.

At block 1650, a decision on whether the system verifies the identity of a principal is made. This decision may be based on numerous factors as specified by the security policy. In some embodiments, a simple sum of all decisions may be made with a certain threshold required for a principal's identity to be verified. For example, if the required threshold is three or more, and six positive results (1), three negative result (−1), and two no-decisions (0) are received, then the sum would be three, and the principal would be authenticated.

In some embodiments, the decision may be based on the sum of the weighted results exceeding a certain threshold. For example, if the required threshold is 0.30 or more, then the principal would not be authenticated because the sum of the weighted results might only equal 0.27.

In some embodiments, the decision may be based on the sum of the weighted results for attempts that actually resulted in a decision. For example, if the required threshold is 0.30 or more, then the principal would be authenticated because the sum of the weighted results for attempts that resulted in a decision might only equal 0.33.

Various additional conditions can be provided for in a security policy which will override or supplement summed results. Merely by way of example, a security policy can specify that additional conditions must be met. For example, that certain guardians must provide positive results, that a minimum number of positive results must be obtained, that a maximum number of rejections cannot be exceeded, that a minimum of the sessions must result in decisions, or that the number of no-decisions cannot exceed a certain number. In some embodiments, such conditions may be applied to all guardians, or may just be applied to some subset of guardians during a verification procedure.

If at block 1650 of FIG. 6, the decision is that the principal's identity is not authenticated, then a denial of authentication is transmitted at block 1660. In parallel, access to any resource on which authentication was predicated can be denied. The security policy may specify any actions that should be taken in case of such result.

Another possible result of block 1650 is that no decision is reached. This may occur for some security policies after applying the parameters of the security policy to the verification session results. In some cases, the process may continue by returning to block 1620, with the security policy being re-applied as if no verification process had been previously attempted, or the security policy may dictate different parameters for subsequent attempts.

If at block 1650 a decision is reached that the user's identity is confirmed, then at block 1670 the security policy is checked again to determine what action should be taken. In addition to transmitting a confirmation, the system may also transmit instructions to a sub-system or client device that access is granted to certain resources. The security policy may specify which resources are thereafter accessible, and which resources are accessible may depend on the specific and/or aggregated results of the verification sessions. In some embodiments, incremental access to resources may be granted as the sessions proceed and positive results are received. Likewise, negative results may incrementally or entirely roll-back access privileges. At block 1680, the necessary communications to implement the security policy directives are transmitted.

In addition to providing authentication services, the system may be able to provide accumulated and stored information regarding principals to services receiving authentication results. The accumulated information may be provided by the principals, potentially at registration, or by third party services who are guaranteeing, at the time of provision, the truthfulness and/or relevance of the information. Entities which use the authentication service may also contribute information over time, such that later such information may be provided to other requesting entities.

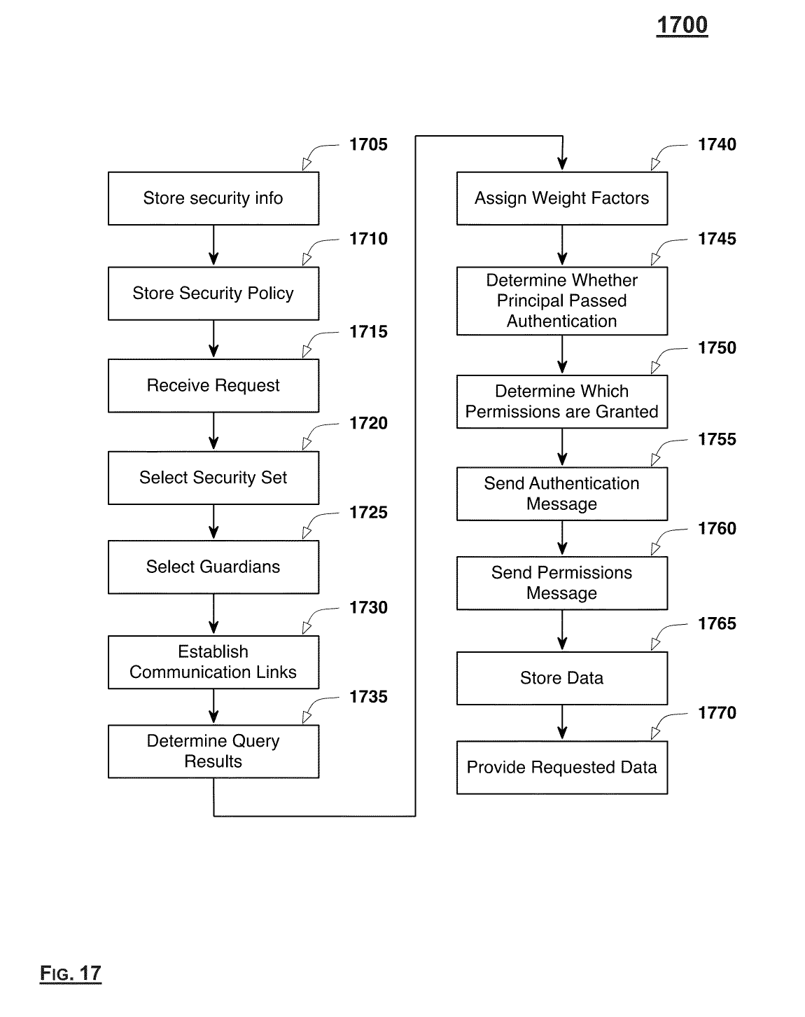

FIG. 17 shows an alternative method 1700 of authenticating the identity of a user. Portions of other embodiments discussed herein may be incorporated into example method 1700, and portions of method 1700 may be incorporated into other embodiments discussed herein.

At block 1705, security information may be stored related to a principal. The security information may include identifiers representing a plurality of guardians, contact information for each identifier, and rating information for each identifier.

At block 1710, a security policy related to a requester may be stored, where the security policy comprises a first security set having verification parameters. A second security set may also be present in the security policy.

At block 1715, a request to authenticate the identity of the principal may be received from the requester.

At block 1720, based on a number of factors, one of the two security policy sets may be selected.

At block 1725, a subset of the identifiers may be selected, where the subset is selected based at least in part on the verification parameters of the selected security set.

At block 1730, communication links may be established, based at least in part on the contact information, between the principal and each of the guardians represented in the subset of identifiers. Communication links may be queued up for the principal, and notifications of the status of the queue provided thereto. Telemetry information may be collected during the communication links, and thereafter affect the trust factors of individual guardians, and/or be used to determine whether to authenticate the principal.

At block 1735, a result may be determined of a query to each of the guardians for whom a communication link with the principal is established, the query asking each guardian whether the principal is a specified party.

At block 1740, a weight factor may be assigned to each of the guardians for whom a communication link with the principal was established.

At block 1745, the method 1700 may determine, based at least in part on the results, the rating information, and the verification parameters whether the principal is authenticated.

At block 1750, which permissions are granted may be determined, based at least in part on the results and at least one permission indicator in the first security set.

At block 1755, an authentication message may be sent, based at least in part on whether the principal is authenticated.

At block 1760, a permission message may be sent, based at least in part on the determination of what permissions are granted.

At block 1765, biographical data related to the guardian may be stored.

At block 1770, a broad range of data types (for example, biographical, personal, professional, etc.), may be provided to the requester, if requested, subject to the outcome of the verification session.

Guardian Input Error Minimization Techniques

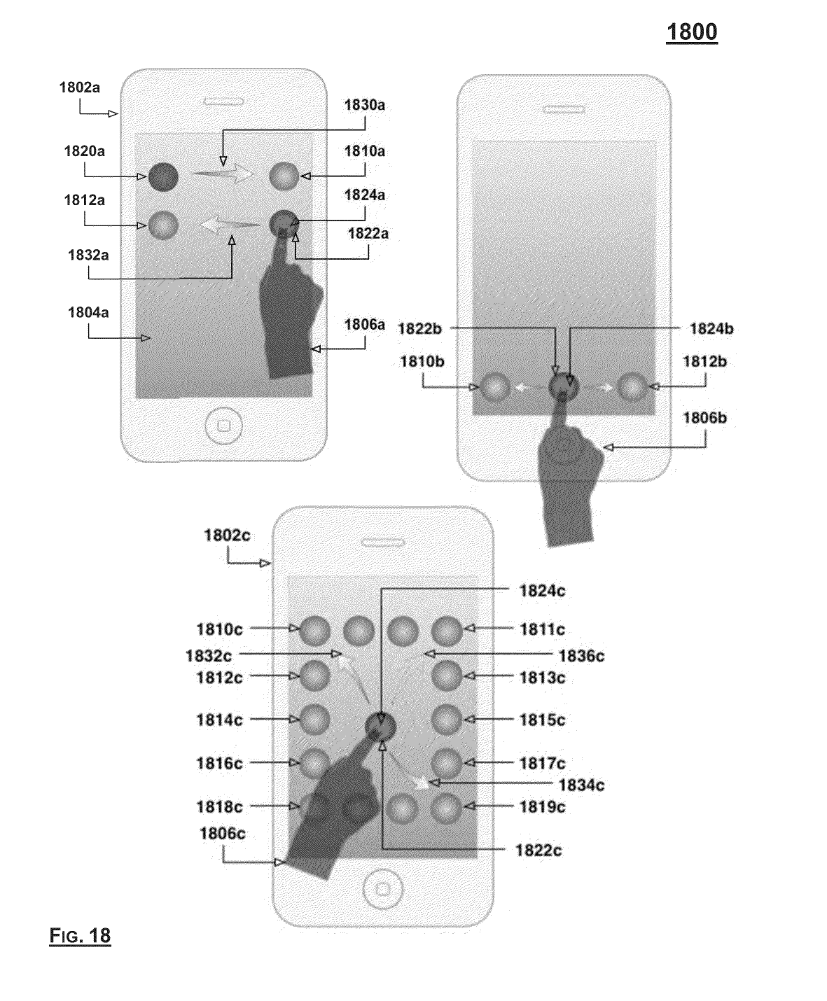

To minimize the number of unintentional gestural mistakes committed by guardians during the verification process, the current method, system and process may utilize several gestural input patterns to increase chances of receiving intentional, as opposed to unintentional, input by the user. FIGS. 18-24 depict a variety of gestures ensuring proper inputs are recognized by guardian client devices where gestural input and capture are facilitated.

While a variety of gestures are presented, to further decrease chances of an unintentional decision input, the method allows randomization of gestures to prevent muscle memory from other guardian use cases resulting in an unintentional input. As a result, the current method may randomize requested gestures from one verification session to another ensuring that the guardian is paying attention and not automatically performing any given function. For example, a gesture that was a confirming action during one authentication process may be switched to a different one for another session, or even swapped during another session to have the opposite function of rejecting principal's identity.

The current method, system, and process, on the client side, may require several consequent actions from the user acting as second and third degrees of confirmation of intentional input, depending on the security policy requirements of the particular verification process. Some of these actions may be to require another distinct gesture pattern or a dialog box requiring user input, require user to provide some other input such shaking of the phone, rotation of the phone in a certain predefined fashion in one or more dimensions, and/or providing additional input via one or more I/O modules of the device.

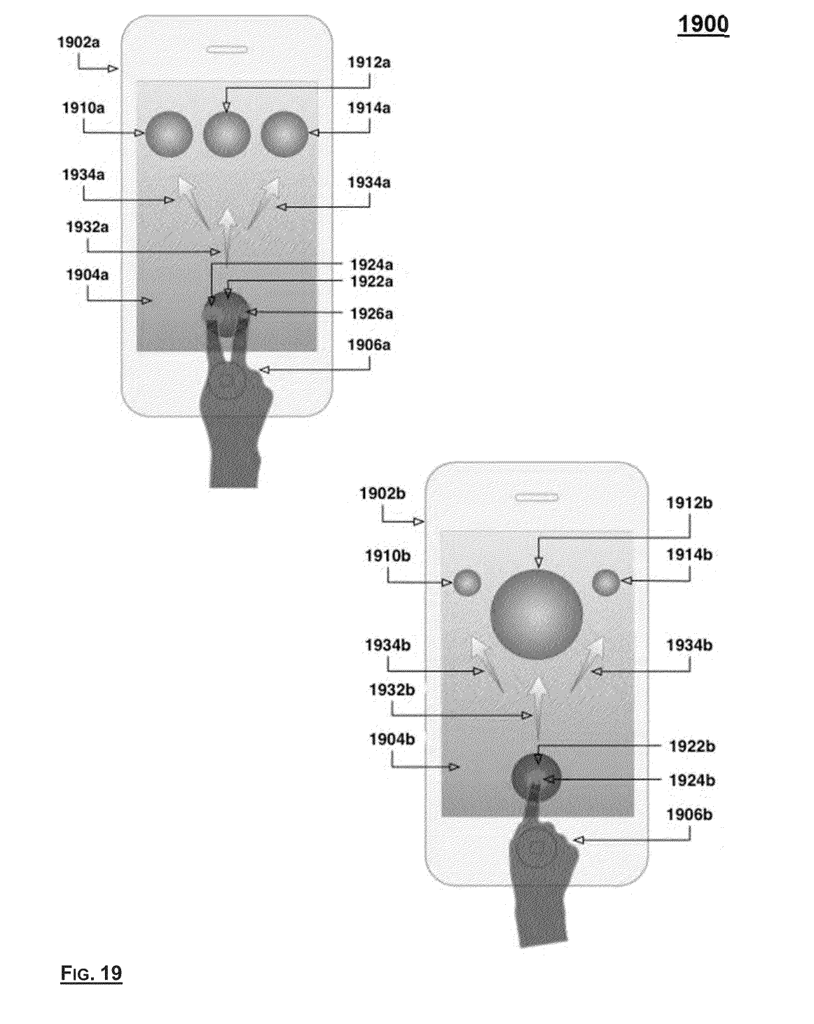

FIG. 18 shows hand gestures 1800 having a number of gestural variations leveraged to ensure the intent behind guardian's input where guardian's touch 1824b has to drag the selection circle containing principal's avatar either left to 1810b or right towards 1812b, both positioned on the same horizontal axis. 1810b and 1812b have visual representations associated with either verifying or failing to verify principal's identity based on the outcome of the communication session. A user may be presented with multiple alternative options associated with verification session and have to choose which path to follow depending on the conditions of the communication session. User may be presented with visual cues and/or tracking pathways 1832c, 1834c, 1836c of varying degrees of intensity for the user to associate with available options and simplify the user's understanding of the requirements. Similar functionality with different gestural vectors and movement paths are portrayed in FIGS. 19-24.

FIG. 19 shows hand gestures 1900 having the ability to accept and differentiate between one or multiple parallel or sequential user inputs 1924c and/or 1926c as part of the acceptance criteria to ensure the input provided by the user was intentionally made by the user to minimize both false positive and false negative user input rates, and consequently minimizing errors in unintentional verification outcomes.

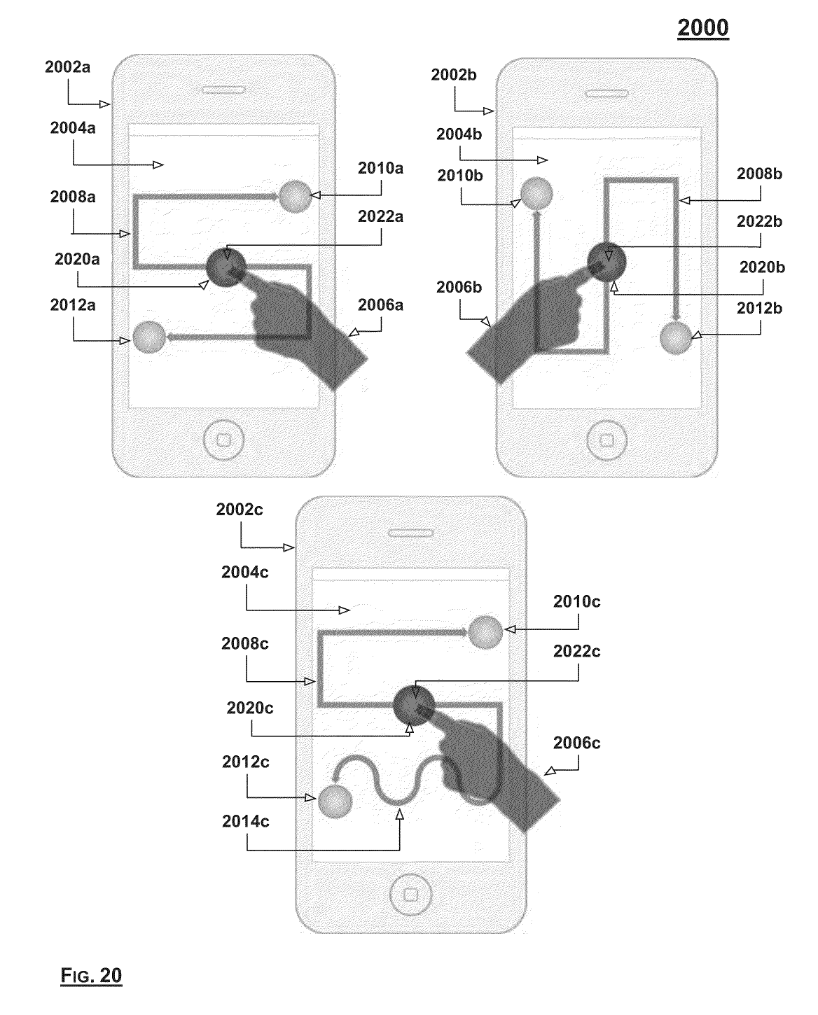

FIG. 20 shows hand gestures 2000 having an enhanced movement/tracking pathway 2008a,b,c of a guardian's input 2022a,b,c, resembling a maze of varying geometries, required to accept by handheld and/or touch-based client device a guardian's decision to either verify or reject confirmation of a principal's identity. The geometry of the pathway a user might be required to follow to confirm user may or may not be static, and may change with time requiring for the user to analyze changes in the geometry of the path towards the final state 2010a,b,c or 2014a,b,c and adapt user's input to match the changing path 2014c. As an example, the initial input path may be symmetrical as depicted in 2008a,b but might be different at another time, such as 2008c and 2014c, and might change based on the input from the user or additional system security policy requirements.

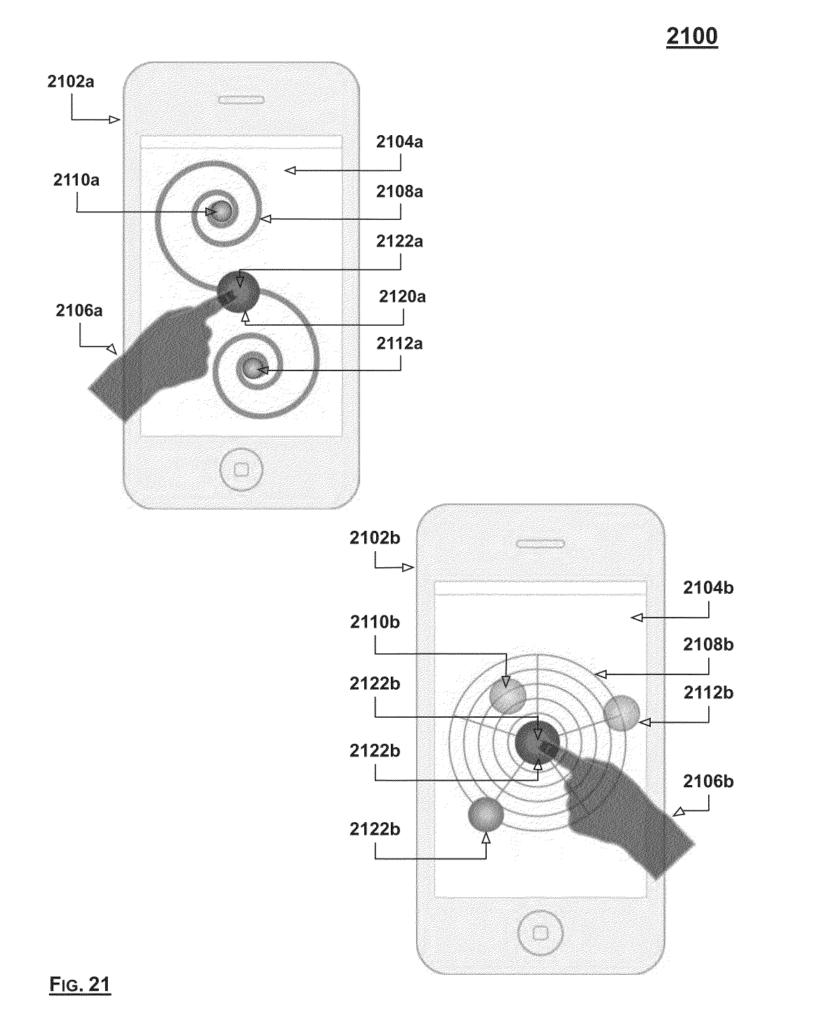

FIG. 21 shows hand gestures 2100 having an enhanced movement/tracking pathway 2108a,b of a user's/guardian's input 2122a,b, resembling a spiral 2108a and a spider-web 2108b, required to accept by handheld and/or touch-based client device a guardian's decision to either verify or reject confirmation of a principal's identity.

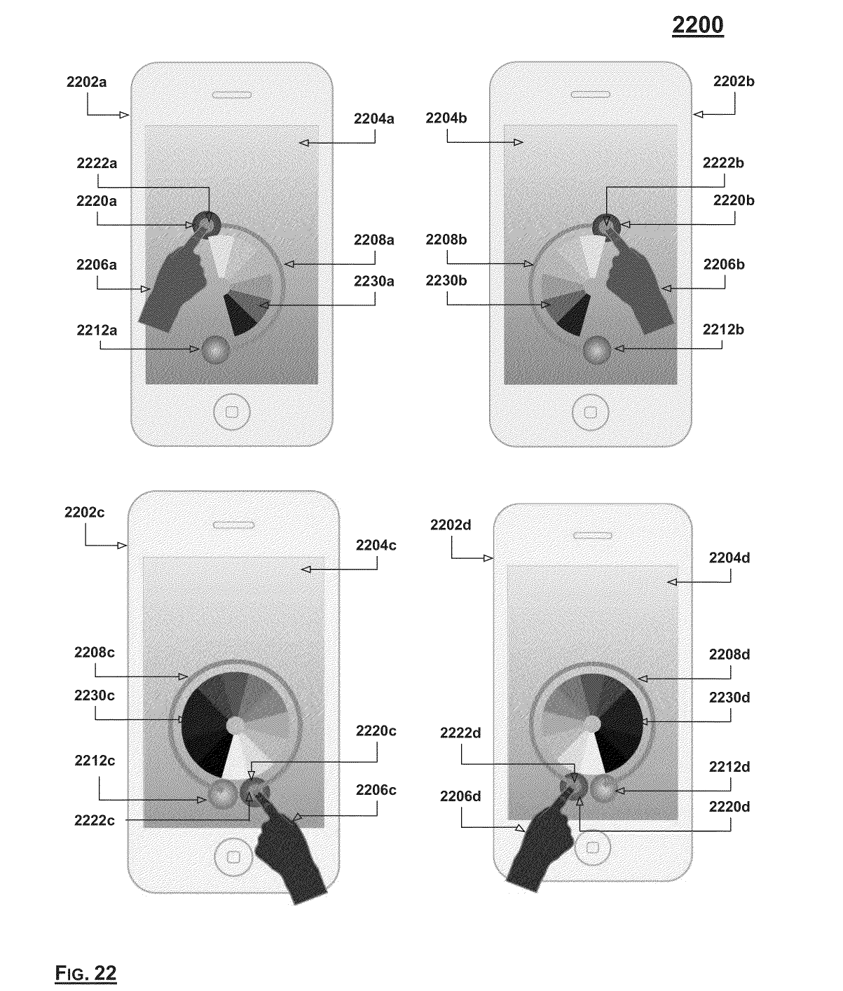

FIG. 22 shows hand gestures 2200 having an enhanced movement/tracking pathway of a guardian's input 2222a,bc,d, following a circular movement of either full-, half-circle or any other radial angle, required by handheld and/or touch-based client device 2202a,b,c,d to accept a guardian's decision to either verify or reject confirmation of a principal's identity.

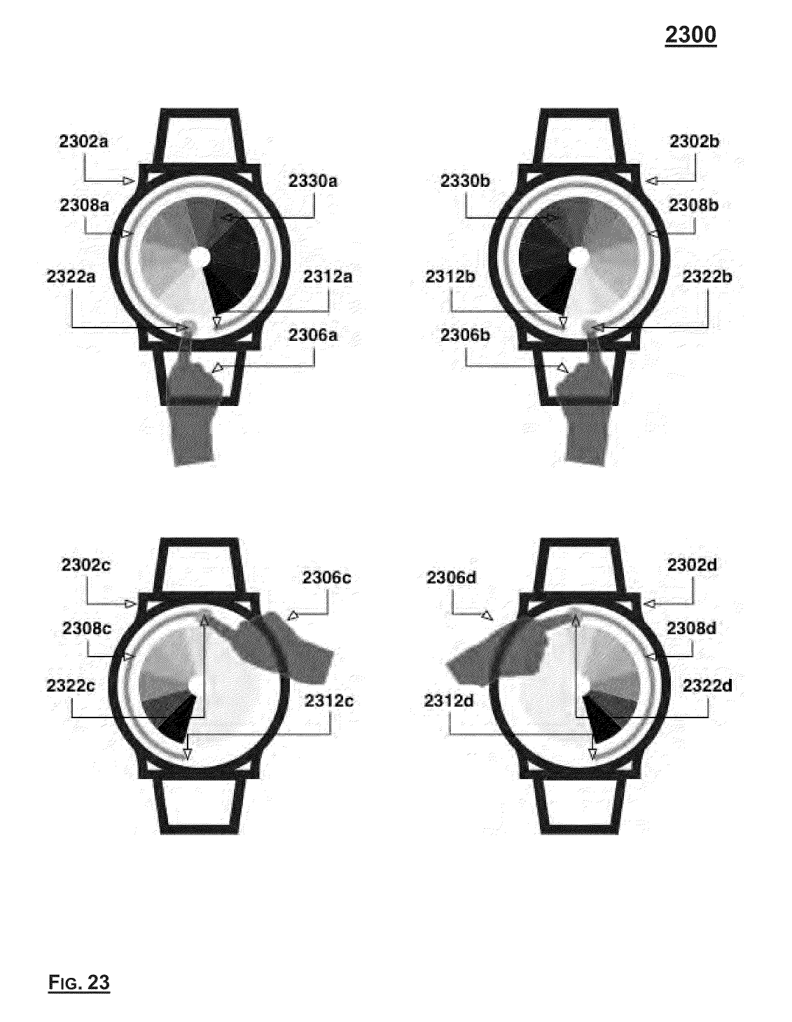

FIG. 23 shows hand gestures 2300 having an enhanced movement/tracking pathway of a guardian's input 2322a,b,c,d, following a circular movement of either full-, half-circle or any other radial angle, required by client wrist-mounted device 2302a,b,c,d, such as a watch, to accept a guardian's decision to either verify or reject confirmation of a principal's identity.

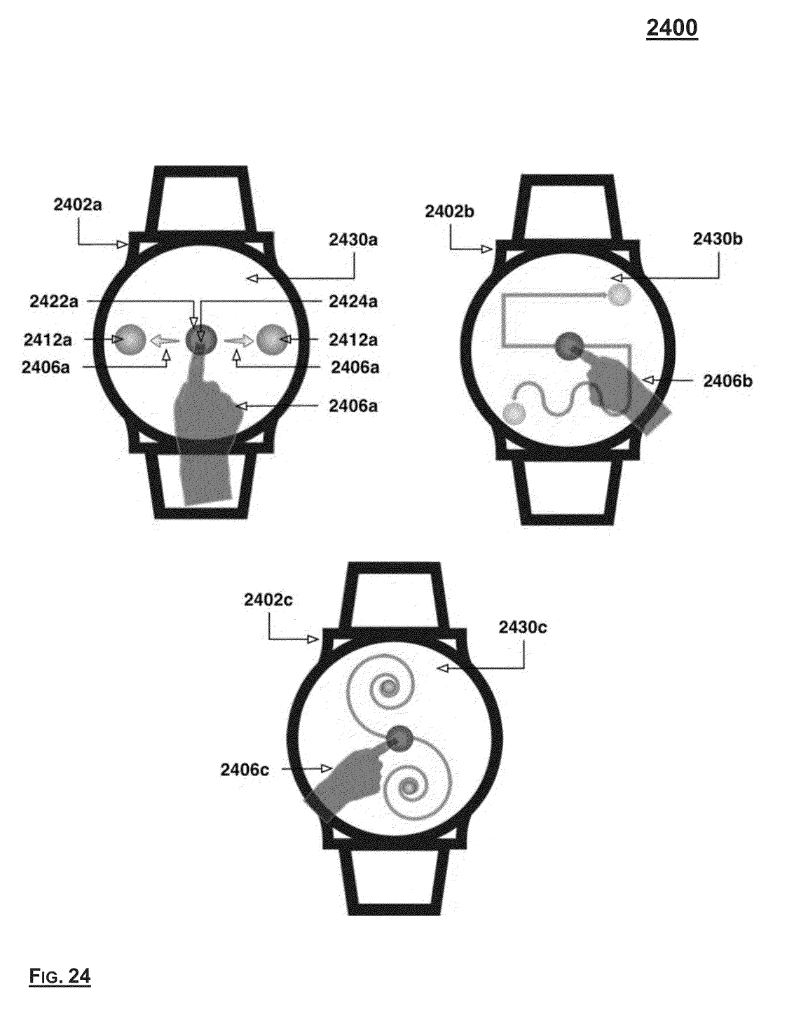

FIG. 24 shows hand gestures 2400 having an enhanced movement/tracking pathway of a guardian's input, following patterns described in FIG. 20, 21, 22, required to accept by client wrist-mounted device a guardian's decision to either verify or reject confirmation of a principal's identity.

Though two-dimensional figure touch gestures, along Y- and X-axis's, might have the broadest range of applications for ease of use from user experience standpoint in commonly available electronic devices, additional haptic inputs, pressure levels, vertical movement along Z-axis, as well as a combination of hand gestures, eye movement, and head movements can be used to portray positive or negative verification session outcomes.

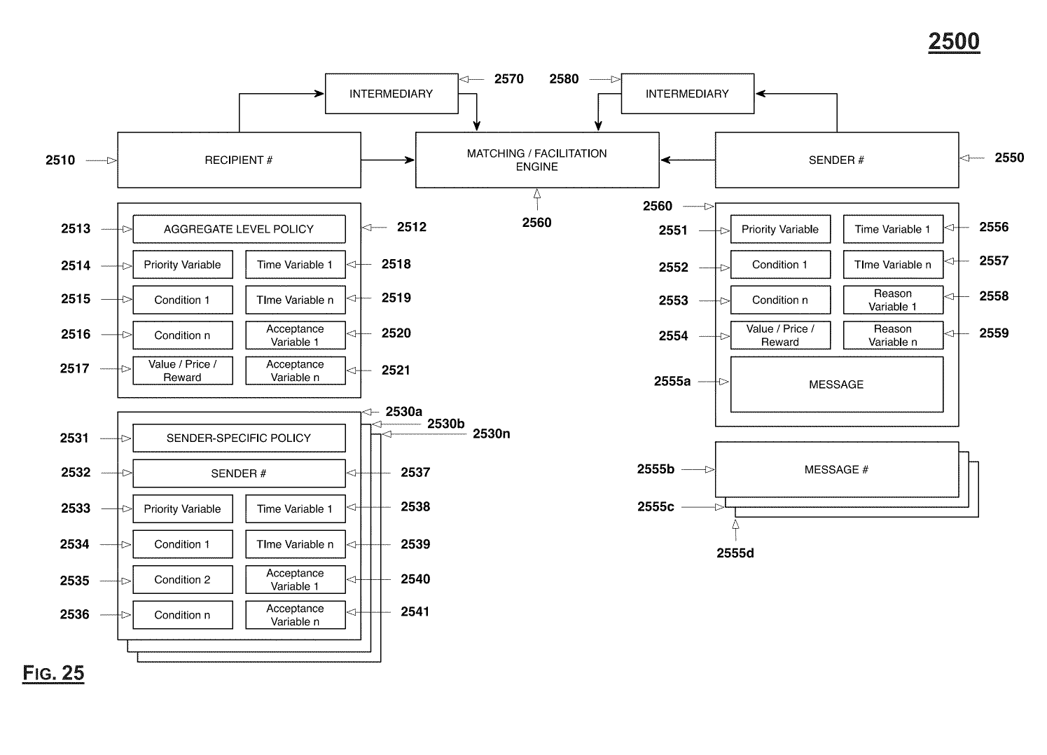

FIG. 25 shows a method 2500 of communication value assignment, verification session prioritization, a messaging session pricing mechanism, and incentive establishment for users and verification guardians. While the application of this method is broader than mere identity verification, in one application method 2500 allows for matching the needs and priorities of principals requiring verification, and those of guardians who value their time and do not want to be disturbed too often. The method will be first described broadly from the perspective of a sender 2550 and recipient 2510 whose interests have to be matched to establish and facilitate the communication session by this method and process. For the purposes of this example, the identity verification session will be most common type where a principal user acts in the capacity of a “sender” who needs something (i.e., a verification session) from a “recipient” who may or may not be available.

From the sender's 2550 standpoint, sender's message body 2555a is encapsulated into the overall message payload 2560 together with several additional inputs associated with the message body 2555a, such as priority variable 2551, time variables 2557, 2558, reason variables 2558, 2559, delivery conditions 2552, 2553, as well as value/price/reward 2554 associated with the successful delivery and acceptance of the message by the recipient 2510. Any of the variables associated with the message body 2555a may be targeted to the final recipient 2510, as well as any of the intermediaries involved in the message delivery, provision of services, or otherwise interested in the establishment and facilitation of the verification session.

From the recipient's 2510 standpoint, recipient can set an aggregate level policy 2513 for all incoming communication messages/verification session requests based on priority variable 2514, time variables 2518, 2519, a set of conditions 2515, 1516, acceptance variables 2520, 2521 as well as expected or threshold value/price/reward for acceptance of the message or verification session request. While the sender can set aggregate level policy for all inbound communications 2512, similar granularity is available on per sender 2532 basis where each sender may have their own set of sender-specific 2532 policy 2530a,b,n comprised of a set of requirements/variables (2533, 2534, 2535, 2536, 2538, 2539, 2540, 2541) similar to the subset defined for aggregate level policy.

While the above method is simplified to that of a sender 2550, recipient 2510 and matching/facilitation engine 2560, this method and process allows for intermediaries 2570, 2580 to add additional conditions, inputs, and incentives to the initial inputs provided by a sender and a recipient to further incentivize both parties to proceed with the communication session. For example, to speed up the response time from the recipient, intermediaries 2570, 2580 may further increase some of the variables such as priority variable 2551, time variable 2556, reason variable 2558, and/or the value/price/reward 2554 associated with the recipient agreeing to respond to the message sent by sender 2550 and establish the communication session or a verification session. Such a strategy, where intermediaries provide additional incentives to match recipient's and sender's mutual expectations and needs, might be commonly used in situations where recipient's 2510 aggregate level policy 2512 is too strict to accept the messages from sender 2550, whose overall set of conditions for that particular message is too low versus the expectations of the recipient. This method improves number of successful verification sessions in scenarios where guardians commonly find themselves overloaded with messages resulting in lack of response to the most critical messages/notifications.

The communication messages and verification sessions may be taking place when the minimum threshold requirements set by the recipients or guardians are matched by the facilitation engine with the requirements of the sender and/or principal, or an intermediary who is incentivized to ensure smooth facilitation of message flow from senders to recipients resulting in verification sessions taking place. This method and process allows for the recipient to notify the facilitation engine 2560, intermediaries 2570, 2580, as well as individual senders 2550, of changes in aggregate level policy 2513 and entire conditional subset 2512, allowing smoother and more effective facilitation of message delivery and verification sessions by communicating minimum threshold requirements to accept and process messages and/or verification requests.

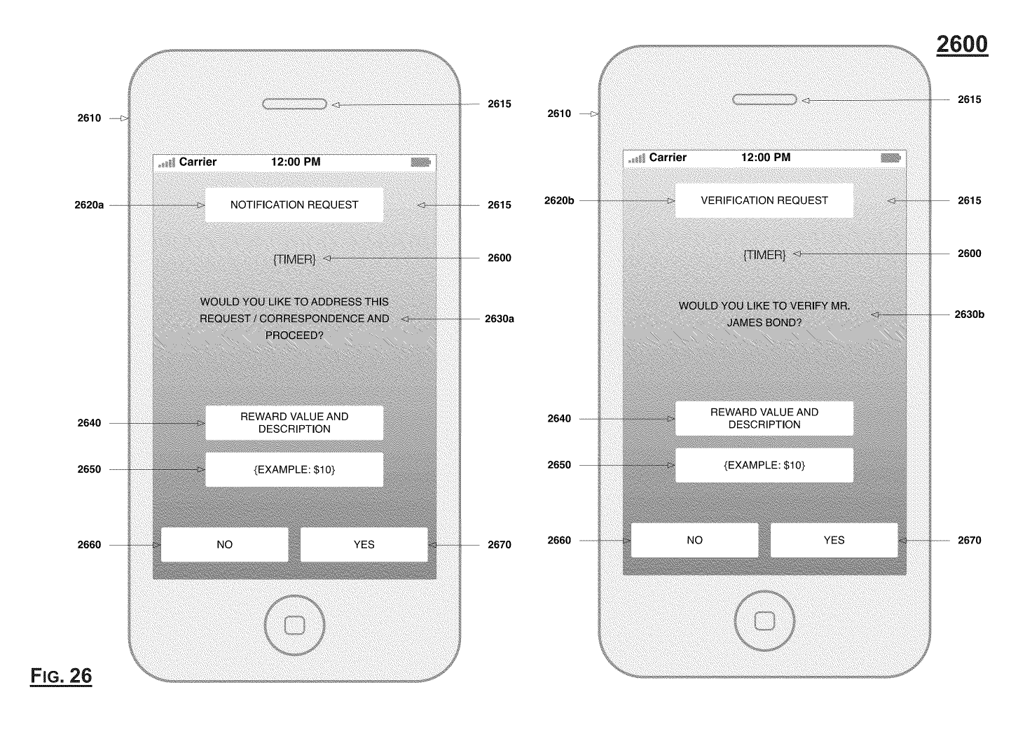

FIG. 26 shows a method 2600 depicting recipient facing notification request presented on a mobile, a wearable, or a temporary device 2610 containing a display 2615 presenting a notification 2620a or a verification request 2620b. The recipient 2510 is presented with a body of the message explaining the nature of the request/correspondence 2630a or a purpose of the verification request 2630b with a name of the person/sender 2550 who is awaiting their identity to be verified by the recipient 2510 acting in the capacity of a guardian. The recipient may or may not be presented with a timer 2600 depicting the fact that the notification message has an expiration component and has to be responded to within the presented time frame. The notification contains a description or a visual representation of the reward value and general description 2640 which may contain some or all of the potential variables defined by the sender 2550 or intermediaries 2570, 2580 in the message payload 2560 together with the actual body of the message 2555a, or a series of messages 2555b,c,d. As an example, in this case monetary value/price (2650) and a reward of $10 was defined by the sender and/or intermediaries to provide an incentive for a recipient to be rewarded if the recipient was to answer the notification message and/or proceed with the verification process. The recipient is presented with controls to accept 2670 or deny the notification request 2660, if the recipient is not available or conditions/variables associated with the notification/message do not meet recipient's expectations or minimum threshold value.

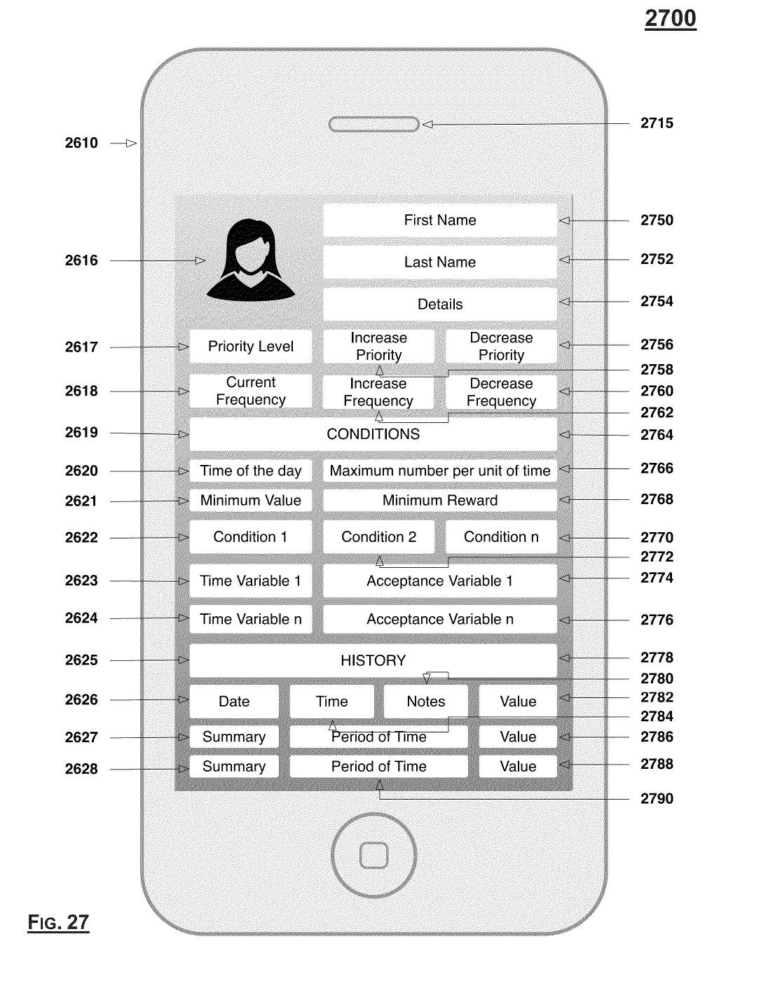

FIG. 27 shows a method 2700 depicting a recipient facing interface presented on a mobile, a wearable, or a temporary device 2710 containing a display 2705 allowing a recipient 2510 to setup and control a sender-specific policy 2530 with respective acceptance criteria, threshold criteria, and conditional variables to accept and process incoming messages and verification requests granularly per each respective sender. In this implementation a recipient is presented with general identification information of a sender (2750, 2752, 2754, 2716) that for example can be a principal who may require verification sessions to take place at a certain frequency with certain level of urgency. The recipient, as an example acting in the role of a guardian, may setup a minimum threshold priority level 2617 at which this recipient will be willing to accept messages and/or verification requests from this sender/guardian. The controls allow the recipient to adjust the priority level by increasing 2758 and decreasing 2756 priority level. As an example, some recipients will only be willing to accept messages/verification requests that either urgent or life-dependent, whereas for others messages of any priority level will be acceptable.

Similarly, a recipient can view current frequency of messages/verification requests 2618, increase 2762 or decrease 2760 acceptable overall frequency of the messages and/or verification requests. As an example, for some recipient/sender pairs, two notifications/verification attempts per day will be acceptable, whereas for other pairs, one notification/verification attempt per week will be a maximum acceptable threshold.

More granular controls are available to further define the conditions 2722, 2770, 2772, time variables 2723, 2724, and acceptance variables 2774, 2776 under which recipient might become available to accept notifications, messages, and/or verification requests. Over time such level of granularity on the recipient side will allow to a natural market equilibrium to be established between senders and recipients, principals and guardians, each of who will be effectively extracting certain value out of the transaction, whether a message, a verification session, or some other service associated with successful delivery of the message to the recipient.

In addition, a recipient is presented with a history of the most recent messages/verification attempts 2625 from this particular sender, including but not limited to date 2726, time 2784, notes 2780, custom data fields 2782, as well as general summary 2727, 2728 over a period of time 2784, 2790, and custom data fields 2786, 2788 associated with each time period and its respective summary of verification periods.

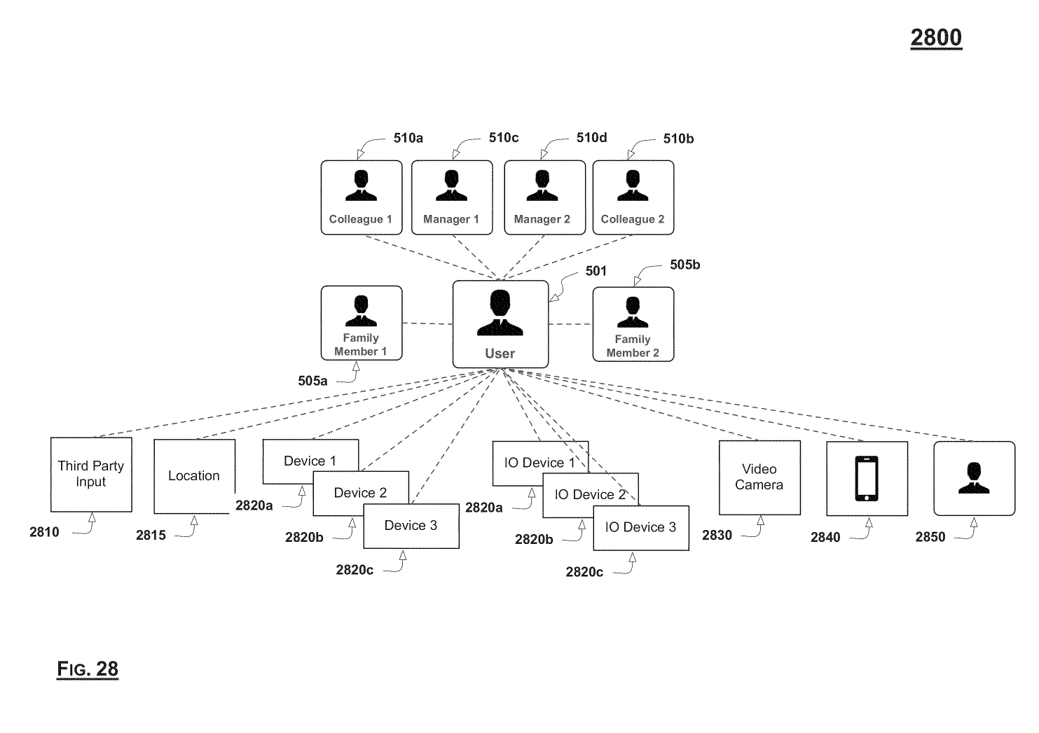

FIG. 28 shows an enhanced method 2800 of authenticating the identity of a user/principal, where verification outcomes from each respective guardian are complemented by additional inputs from third party inputs 2810, location data 2815, video, photo, infra-red capture device 2830, among a variety of input/output devices 2820a,b,c that can supplement the final verification outcome, and matching additional security policy requirements in certain applications.

The current invention may leverage a variety of devices 2820a,b,c belonging to the actual user/principal, such as a mobile device or a tablet 2840 for storage of data, performance of computational operations, and/or rendering a set of duties before, during and after the verification session. The information stored in an overlapping, distributed, and/or replicated manner may be used both during the actual verification to help validate the identity of the principal, as well as be used for storage and retrieval information to be provided to the principal or a third party who requested verification of the user after the verification session has been completed. It is important to recognize that, depending on the outcome of the verification session, different data points may be provided and different functions performed.

Some embodiments may integrate additional third parties 2850, who are not an active current guardian of the principal, but because this particular party 2850 at the moment of the verification session happens to match certain set of conditions predefined by the security policy, may still act as an additional provider of a verification decision regarding the user.

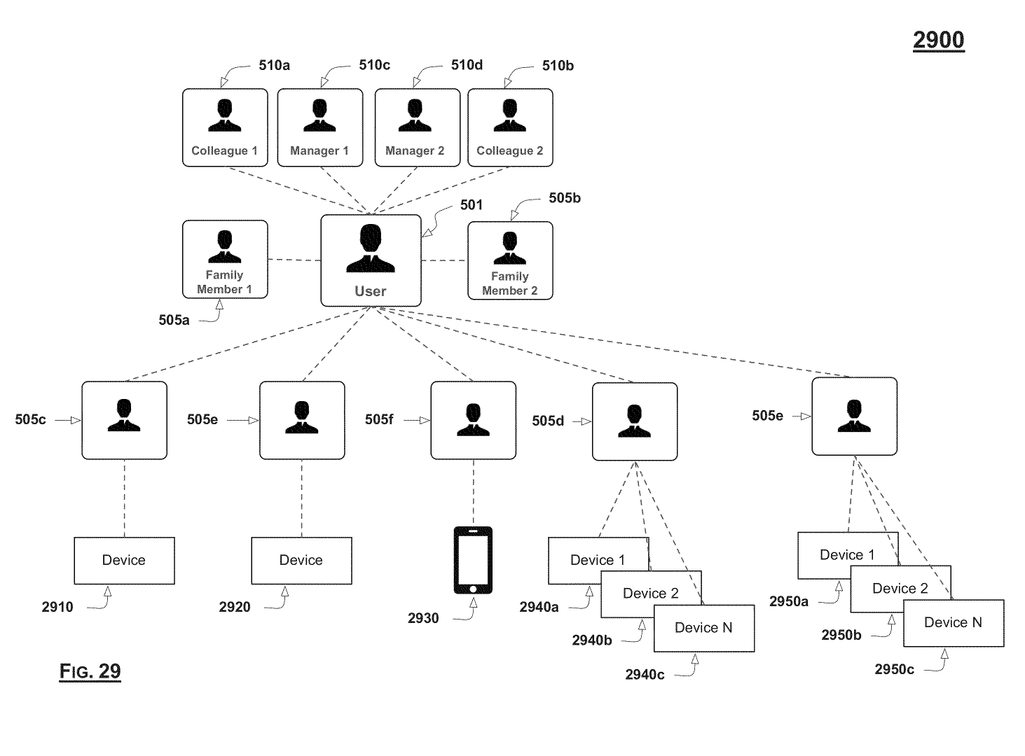

FIG. 29 shows a detailed breakdown of the device level representation of each guardian 505,510 for the user/principal 501. For example, guardians 505c and 505e are represented by a single individual device 2910 and 2920, respectively, to be directly involved as the verification clients with which the core service will establish a connection (voice, data, audio, video, etc.) or a feedback loop. As an example, for guardian 505f the device is a mobile phone or a pad 2930, whereas devices 2910 and 2920 may be represented by any electronic device capable of storing the information, and/or processing commands, and/or rendering communication messages in a way understandable to a human such auditory, visual, haptic mechanisms, among many others.

Guardian 505d may have multiple devices 2940a,b,c, either replicating each other's functionality or providing different types of functionality to the guardian. While all three devices may not be used during the actual verification session in parallel, in some situations they may be, and as an example both 2940b and 2940c may be used to provide the necessary functions to conduct verification sessions. The second function of these multiple devices may be processing and storage of data for several functions that can be of use during the verification session of the user 501. As an example, certain data points can be stored in distributed and/or mirrored and/or overlapping manner to be used either during the verification session or for retrieval and assembly of data and performance of certain functions as the result of the verification session decision of principal 501.

As an example, during a verification session the core service may request to receive certain data points, perform processing operations, and/or conduct or physical/mechanical operations from all or a certain subset of guardians 505-510 of the principal 501. Even though not all guardians may actually be participating in a particular series of verification sessions, their devices may still be involved in rendering certain sets of functions. Similarly, after the verification session is completed, depending on the outcome of the verification session, the system may request to receive certain data sets and/or perform certain processing or mechanical functions from the devices of all guardians or a subset of guardians of the principal.

A distributed approach to data storage and data processing provides additional level of security against intrusion attempts. This implementation of the invention provides inherent strength to the system, particularly in situations of network or connectivity outage. As an example, if the guardian with its subset of devices cannot be reached due to network connectivity issues, their devices may not be available to provide data or perform any additional functions before, during or after the verification process, regardless of the verification outcome. As a result, intruders won't be able to retrieve the data from these devices after the verification session is completed by maliciously introducing a network outage for the duration of the verification session. This mechanism adds simplicity and strength to the system, providing a potentially fail-proof mechanism against induced connectivity outages to inhibit natural strengths of a large verification circle. Hence, if the guardian with their subset of devices is not available, they won't be able to perform the functions necessary for a verification session, or a consequent sequence of events triggered by an outcome of the verification session. It is important to note that while devices 2910, 2920, 2930, 2940a,b,c, 2950a,b,c, may not belong to principal 501, they may still be used for storage and processing of data for the purposes of principal 501, either before, during, or after the verification session.

For example, if guardian 505e wasn't available for one particular verification session, his devices 2950a,b,c may still be used to either retrieve certain data points, and/or perform certain operations or tasks for the purposes of verification session of principal user 501, which can take place either before, during or after the actual verification session. On the other hand, depending on the security policy, the additional security measures described above, if guardian 505e couldn't be reached before and/or during and/or after the verification session of principal 501, as none of guardian's 505e devices 2950a,b,c could've been reached, the security policy may prevent provision of certain tasks or data points as they simply could've been provided by the devices 2950a,b,c that are off the grid at the particular period of time. In summary then, in any of the embodiments discussed herein, a verification session with any particular guardian could leverage an amalgamation of all devices belonging to that particular guardian, which can be comprised of an individual device or multiple devices belonging to each guardian as described above.

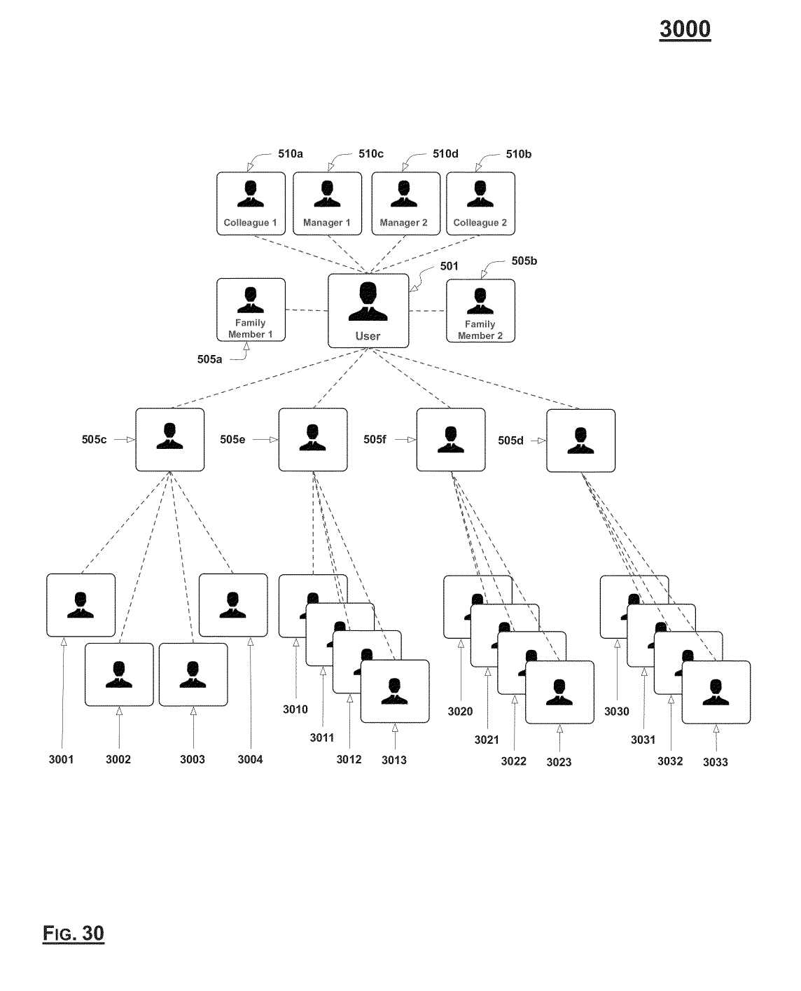

FIG. 30 shows an enhanced method 3000 where principal 501 is verified by his/her guardians 505c,e,f,d, who are in return required to go through a verification procedure themselves by their respective guardians 3001-3004, 3010-1013, 3020-3023, 3030-3033, respectively. Consequently, for example, guardians 3001-3004 with the amalgamation of their respective devices act as second degree guardians to user 501. As an example, the second-degree verification of principal 505c by his/her guardians 3001-3004, may take place either before, during or after the actual verification session of principal 501 by guardian 505c.

This figure depicts the capacity to leverage second, third, n degree connections between persons to store and assign processes in a distributed fashion to minimize aggregate system risks. Consequently, principal user's 501 information, parts of the information, or associated processes may be stored, rendered, or executed on the device of second-degree guardian 3001, or an amalgamation of devices of second-degree guardian 3002, who may not necessarily know principal 501 directly, while indirectly contributing resources to the verification process of principal 501.

As a result of a network effect, the strength of this method and process gets amplified by leveraging n-degree connections across users who may or may not know each other directly and their respective sets of devices. At any given point in time a principal user 501 may be verified by a varied subsets of guardians, some of whom know the principal 505a,b, 505e, and some may not 3001, 3031, 3032. Leveraging n-degree connections across users with their respective device subsets provides the ability for this method and process to leverage both a device subset of a guardian 3023 and a guardian network of user 3023 in the role of a principal, considering the fact that user 3032 is not part of user's 501 guardian network, and may or may not know user 501 directly. Thus, the current method and process allows leveraging both respective guardian circles and device subsets to strengthen statistical significance of the verification outcome of principal user 501.

Consequently, and for example, user 3020 may be directly involved in verification of principal 501) whether acting as a guardian verifying the identity of a user 505f, who will in turn act as one of the guardians for principal user 501) providing the resources of user's 3020 personal devices to contribute processing and data storage capacity necessary for verification of both users 505f and 501, even though users 3020 and 501 are not directly related or even aware of each other's contribution to the strength of the verification process within the method and process of various embodiments.

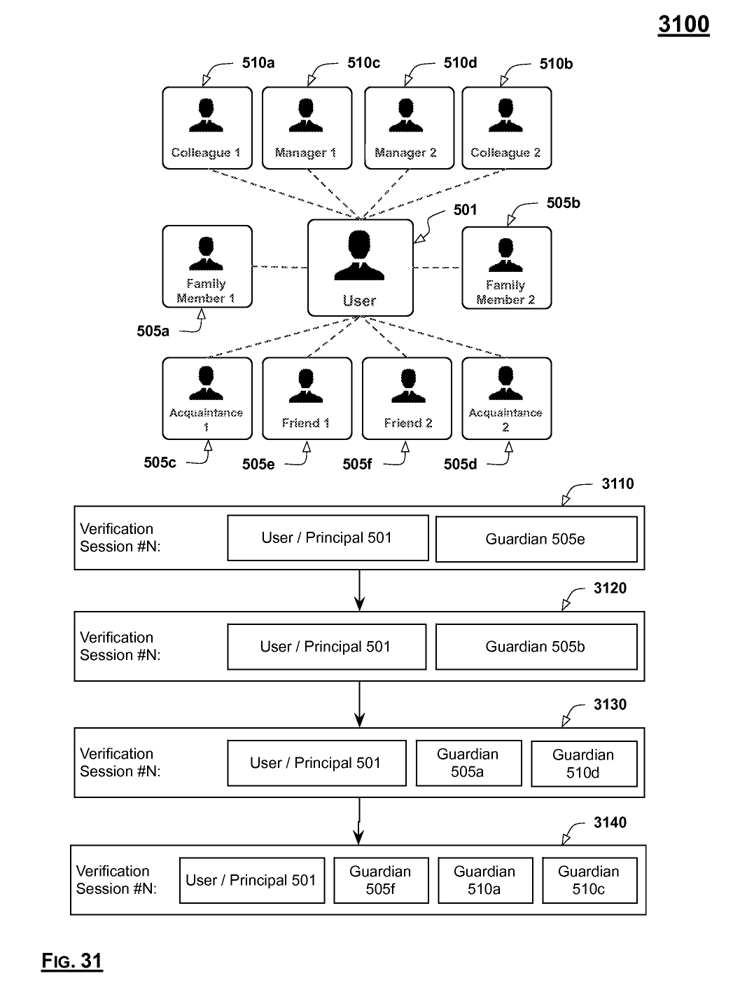

FIG. 31 shows an enhanced method 3100 of authenticating principal 501 by multiple guardians at the same time as a part of the same communication session, such as during the verification session 3130 when principal 501 is interacting with guardians 505a and 510d at the same time as part of the same communication session, in which guardian 505a and 510d may or may not know about each other's participation, or alternatively may be aware and actively interacting between each other and the principal. A similar process takes place in 3140 where three guardians 505f, 510a, 510c are participating in the verification session. This method may be applicable to environments where a security policy allows for guardians to know each other identities, and particularly relevant for corporate and high security facilities where verification is required by nature of obligation and contract. For example, in session 3140, principal's colleague 510a and manager 510c may be a part of the same communication session with the principal, and organization security policy may allow inclusion of principal's friend 505f as part of the communication session for a variety of reasons, where 510a and 510c may want to observe the interaction between principal 501 and guardian 505f or ask additional set of questions to guardian 505f about the principal or vice versa.

Nevertheless, in environments with a less strict security policy and/or for privacy reasons of guardians and principals, it may be more common to employ one-on-one verification sessions such as 3110 and 3120, during which principal 501 is being verified by guardian 505e, and guardian 505b, respectively, as part of separate communication sessions, where guardians are queued up one after another.

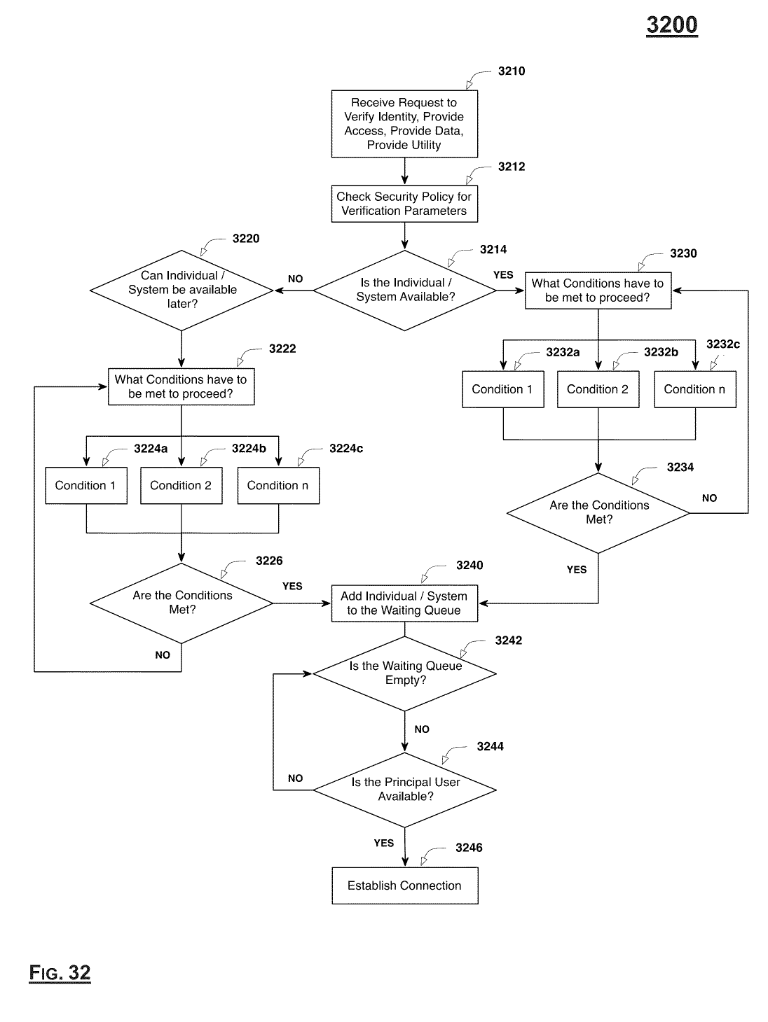

FIG. 32 shows a block diagram of an exemplary process of identifying a subset of guardians available for a verification session with a principal. At block 3210, the system receives a request to verify an identity of a principal, provide access permission, provide data, and/or provide a utility associated with a principal. At block 3212, the system checks the security policy for verification parameters associated with the type and conditions of the request received at block 3212. At block 3214, after identifying the parameters, individual guardians, and systems that are allowed/required to be used for this request, the system checks the availability of the individual guardian, group of guardians, and/or systems.

If an individual, group of individuals, or a system is not available at block 3214, then at block 3220 the system checks whether any and/or all conditions/variables can be met for each resource (individual, group, or system) needed for the notification/verification request. The conditions and variables that the system will be checking against are those defined by the recipient 2510 in FIG. 25 relating to minimum threshold values defined by the guardian recipient 2510 on aggregate policy level 2513 and on individual sender-specific policy level 2530a,b,c. If such conditions exist 3224,b,c, the core system will continuously check whether any of the conditions are met at block 3226, until a time one and/or all of these conditions are met and the resource becomes available to proceed to block 3240 where that particular resource is placed into the waiting queue at block 3240.

If an individual, group of individuals, or a system is available at block 3214, then at block 3230 the system checks whether any additional conditions have to be met for a resource (individual, group, or system) to proceed with the verification session. If such conditions exist 3224,b,c, the system will be continuously checking whether any and/or all of the conditions were met at block 3234, until a time one and/or all of these conditions are met to proceed to block 3240 where that particular resource will be placed into the waiting queue at block 3240.

While it is common to have binary outcomes from message filtering, meaning that a message either exceeds the threshold value and passes to the recipient or is below the threshold and gets blocked, some embodiments of the current invention may conditionally associate a time-variable to the priority/urgency variable both for senders and recipients. This means that while in some situations the initial message may not be immediately passed through to the recipient because its priority order didn't match the threshold value, the recipient may still receive it at later point of time when certain conditions have changed. Such a change can be as simple as flow of time, or possibly when the recipient has lowered/relaxed the threshold policy value. Such time-variable assignment and message delivery control reduces the number of blocked messages, while ensuring optimal delivery at times/conditions most appropriate to the recipient, hence increasing the utility/convenience to both sender and recipient, as the message is actually delivered at a time point and/or situation where the recipient is best positioned to capture and process the meaning of the message/event.

At block 3242 the system checks whether the waiting queue is empty—if the waiting queue is not empty and a resource is available (guardian, group, system), the core system checks whether principal user is available. If at block 3244 the system determines that the principal is available, the system will proceed to establish the connection/verification session at block 3246 between the principal user and the resource available from the waiting queue. The selection from within the waiting queue may follow a variety of determination mechanisms, such as last-in-first-out, first-in-first-out, or be determined based on the conditions of the security policy, conditions, and/or variables provided by the resource (guardian, group, system) itself, as well as conditions and variables provided by the principal user, described in FIG. 25, such as priority variable 2551, time variable 2556, condition variable 2553, reason variable 2559, and/or price/value/reward 2554.

The invention has now been described in detail for the purposes of clarity and understanding. However, it will be appreciated that certain changes and modifications may be practiced within the scope of the appended claims. {ESSDKISSMISS}

What is claimed is:

1. A machine implemented method of authenticating the identity of a principal, the method comprising:
storing security information related to the principal, wherein the security information comprises:
identifiers representing a plurality of guardians;
contact information for each identifier; and
rating information for each identifier;
storing a security policy related to a requester, wherein the security policy comprises a first security set having verification parameters;
receiving, from the requester, a request to authenticate the identity of the principal;
selecting a subset of the identifiers, wherein the subset is selected based at least in part on the verification parameters;
attempting to establish communication links, based at least in part on the contact information, between the principal and each of the guardians represented in the subset of identifiers;
determining a result of a query to each of the guardians for whom a communication link with the principal is established, the query asking each guardian whether the principal is a specified party;
determining, based at least in part on the results, the rating information, and the verification parameters, whether the principal is authenticated as the specified party; and
sending, based at least in part on whether the principal is authenticated, an authentication message.

2. The machine implemented method of authenticating the identity of a principal, as in claim 1, wherein:
the rating information comprises a trust factor;
the verification parameters include a threshold value; and
determining, based at least in part on the results, the rating information, and the verification parameters whether the principal is authenticated comprises:
summing at least the products of a plurality of variables, the plurality of variables including a numerical representation of the result of each query and the trust factor of the guardian queried; and
comparing the sum to the threshold value, wherein when the sum exceeds the threshold value, the guardian is authenticated.

3. The machine implemented method of authenticating the identity of a principal, as in claim 2, wherein:
the method further comprises revising the trust factor associated with a guardian based at least in part upon the guardian's participation in the method.

4. The machine implemented method of authenticating the identity of a principal, as in claim 2, wherein:
the method further comprises assigning each of the guardians for whom a communication link with the principal is established a weight factor; and
the plurality of variables further includes the weight factor of the guardian queried.

5. The machine implemented method of authenticating the identity of a principal, as in claim 1, wherein:
the verification parameters specify at least one selection from the group consisting of:
a number of guardians to be represented in the subset of identifiers; and
characteristics of at least one guardian represented in the subset of identifiers.

6. The machine implemented method of authenticating the identity of a principal, as in claim 1, wherein:
the first security set further comprises at least one permission indicator; and
the method further comprises:
determining, based at least in part on the results and at least one permission indicator, what permissions are granted; and
sending, based at least in part on the determination of what permissions are granted, a permission message.

7. The machine implemented method of authenticating the identity of a principal, as in claim 6, wherein:
the security policy further comprises a second security set having verification parameters and at least one permission indicator;
wherein the method further comprises selecting one of the first security set or the second security set for use in authenticating the principal, wherein the selecting step is based at least in part on at least one selection from a group consisting of:
selection criteria in the security policy;
an identity of the principal; and
a specific permission requested.

8. The machine implemented method of authenticating the identity of a principal, as in claim 7, wherein:
the verification parameters of the first security set are different than the verification parameters of the second security set; and
the subset of identifiers selected based at least in part on the verification parameters of the first security set are different than the subset of identifiers selected based at least in part on the verification parameters of the second security set.

9. The machine implemented method of authenticating the identity of a principal, as in claim 7, wherein:
the at least one permission indicator of the first security set is different than the at least one permission indicator of the second security set; and
the permissions granted based at least in part on the at least one permission indicator of the first security set are different than the permissions granted based at least in part on the at least one permission indicator of the second security set.

10. The machine implemented method of authenticating the identity of a principal, as in claim 1, wherein:
attempting to establish communication links is further based at least in part on a first communication address associated with the requester and a plurality of communication address associated with the guardians represented in the subset of identifiers.

11. The machine implemented method of authenticating the identity of a principal, as in claim 1, wherein:
attempting to establish communication links is further based at least in part on a first communication address associated with the guardian and a plurality of communication address associated with the guardians represented in the subset of identifiers.

12. The machine implemented method of authenticating the identity of a principal, as in claim 1, wherein:
the result of the query to each of the guardians for whom a communication link with the principal is established is represented by a numerical value, and the numerical value:
is ‘1’ for a verification that the principal is the specified party;
is ‘−1’ for an assertion that the principal is not the specified party; and
is ‘0’ for when the guardian does not answer the query.

13. The machine implemented method of authenticating the identity of a principal, as in claim 1, wherein:
the method further comprises:
storing data related to the principal; and
providing at least a portion of the stored data to the requester upon authentication of the principal.

14. The machine implemented method of authenticating the identity of a principal, as in claim 1, wherein:
at least one communication link is established via a mobile device of a guardian; and
the method further comprises receiving telemetry information from the mobile device, the telemetry information related to a time period during which the communication link is active.

15. The machine implemented method of authenticating the identity of a principal, as in claim 14, wherein:
the method further comprises changing the rating information for the guardian based at least in part on the telemetry information.

16. The machine implemented method of authenticating the identity of a principal, as in claim 14, wherein:
determining whether the principal is authenticated is further based at least in part on the telemetry information.

17. The machine implemented method of authenticating the identity of a principal, as in claim 1, wherein:
established communication links are queued for the principal in order of establishment of connection; and
the method further comprises causing an indicator to be provided to the principal during a first communication link when a second communication link is queued for the principal.

18. The machine implemented method of authenticating the identity of a principal, as in claim 1, wherein:
the plurality of guardians are at least partially predetermined by the principal.

19. The machine implemented method of authenticating the identity of a principal, as in claim 1, wherein:
the plurality of guardians are at least partially predetermined by the requester.

20. The machine implemented method of authenticating the identity of a principal, as in claim 1, wherein:
the subset is further selected based at least in part on a history of at least one of the guardians.

21. The machine implemented method of authenticating the identity of a principal, as in claim 20, wherein:
at least one guardian is not selected based on their availability or performance during at least one previous authentication session.

22. The machine implemented method of authenticating the identity of a principal, as in claim 21, wherein:
the at least one guardian was not available during the at least one previous authentication session.

23. The machine implemented method of authenticating the identity of a principal, as in claim 1, wherein:
the method further comprises communicating to at least one of the subset of guardians an incentive for participating in a communication session and providing an answer to a query.

24. The machine implemented method of authenticating the identity of a principal, as in claim 23, wherein:
the method further comprises determining whether a threshold preset by a guardian is met by an incentive provided for an authentication session; and
establishing a communication link with the guardian only if the threshold is met by the incentive.

25. The machine implemented method of authenticating the identity of a principal, as in claim 1, wherein:
the method further comprises:
verifying the identity of the principal via physical or electronic documentation; and
providing authentication services to the principal prior to verification via physical and/or electronic documentation on a probationary basis.

26. The machine implemented method of authenticating the identity of a principal, as in claim 1, wherein:
the method further comprises causing video and/or audio elements of an establish communication link between the principal and a guardian to be masked.

27. The machine implemented method of authenticating the identity of a principal, as in claim 1, wherein:
the method further comprises verifying data is present on at least one electronic device of the principal; and
determining whether the principal is authenticated as the specified party is further based upon verifying the data is present.

28. The machine implemented method of authenticating the identity of a principal, as in claim 1, wherein:
the method further comprises verifying data is present on at least one electronic device of a guardian; and
selecting the guardian for inclusion in the subset is further based upon verifying the data is present.

29. The machine implemented method of authenticating the identity of a principal, as in claim 1, wherein:
attempting to establish communication links between the principal and each of the guardians comprises establishing at least one three-way communication link between the principal and at least two guardians.

30. The machine implemented method of authenticating the identity of a principal, as in claim 1, wherein:
the method further comprises verifying data is present on at least one electronic device of a guardian; and
determining whether the principal is authenticated as the specified party is further based upon verifying the data is present.

31. The machine implemented method of authenticating the identity of a principal, as in claim 1, wherein:
the method further comprises executing at least one process on at least one electronic device of a guardian; and
determining whether the principal is authenticated as the specified party is further based upon successful execution of the at least one process.

32. A non-transitory machine readable medium having instructions stored therein for authenticating the identity of a principal, the instructions executable by a machine to:
store security information related to the principal, wherein the security information comprises:
identifiers representing a plurality of guardians;
contact information for each identifier; and
rating information for each identifier;
store a security policy related to a requester, wherein the security policy comprises a first security set having verification parameters;
receive, from the requester, a request to authenticate the identity of the principal;
select a subset of the identifiers, wherein the subset is selected based at least in part on the verification parameters;
determine a result of a query to at least one of the subset of the guardians, the query asking each guardian whether the principal is a specified party;
determine, based at least in part on the results, the rating information, and the verification parameters whether the principal is authenticated as the specified party; and
send, based at least in part on whether the principal is authenticated, an authentication message.

33. The non-transitory machine readable medium of claim 32, wherein the at least one of the subset of guardians determines whether the principal is the specified party by an in-person interaction with the principal.

34. A system for authenticating the identity of a principal, wherein the system comprises:
a server, wherein the server is configured to:
store security information related to the principal, wherein the security information comprises:
identifiers representing a plurality of guardians;
contact information for each identifier;
and
rating information for each identifier;
store a security policy related to a requester, wherein the security policy comprises a first security set having verification parameters;
receive, from the requester, a request to authenticate the identity of the principal;
select a subset of the identifiers, wherein the subset is selected based at least in part on the verification parameters;
attempt to establish communication links, based at least in part on the contact information, between the principal and each of the guardians represented in the subset of identifiers;
determine a result of a query to each of the guardians for whom a communication link with the principal is established, the query asking each guardian whether the principal is a specified party;
determine, based at least in part on the results, the rating information, and the verification parameters whether the principal is authenticated as the specified party; and
send, based at least in part on whether the principal is authenticated, an authentication message.
